(19) United States
(12) Patent Application Publication
(10) Pub. No.: US 2010/0291481 A1
(43) Pub. Date: Nov. 18, 2010

(54) TONER, DEVELOPER, IMAGE FORMING METHOD, PROCESS CARTRIDGE AND DEVELOPER TO BE SUPPLIED

(76) Inventors: Saori YAMADA, Shizuoka (JP); Hisashi Nakajima, Shizuoka (JP); Shinya Nakayama, Shizuoka (JP); Yohichiroh Watanabe, Shizuoka (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/777,673

(22) Filed: May 11, 2010

(30) Foreign Application Priority Data
May 18, 2009 (JP) 2009-119816
Aug. 4, 2009 (JP) 2009-181602

(51) Int. Cl. G03G 9/08; G03G 9/087; G03G 9/09

(52) U.S. Cl. 430/108.2; 430/108.1; 430/108.4; 430/108.8

(57) ABSTRACT

A toner including: a binder resin containing at least a polyester resin (A) and a polyester resin (B) as main components; a colorant; a release agent; and a graft polymer containing a polyolefin resin and a vinyl resin, wherein the polyester resin (A) is a condensation product resulting from condensation polymerization between an alcohol component containing a dihydric alcohol compound, and a carboxylic acid component containing a rosin compound, and the rosin compound occupies 5% by mass or more of the total amount of the alcohol component and the carboxylic acid component, and wherein the polyester resin (B) is a condensation product resulting from condensation polymerization between an alcohol component containing a dihydric alcohol compound which includes at least an alkylene oxide adduct of a bisphenol compound represented by General Formula (1) below, and a carboxylic acid component:

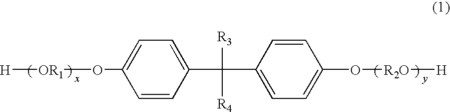

### BACKGROUND OF THE INVENTION

1. Field of the Invention

The present invention relates to a toner, a developer, an image forming method, a process cartridge, and a developer to be supplied, which can be suitably used in an electrophotographic system related, for example, to a copier, electrostatic printing, a printer, a facsimile or electrostatic recording, notably in an ultrahigh-speed printing system adaptable to the field of print on demand (POD).

2. Description of the Related Art

In recent years, demands for energy saving and increase in speed have been heightening in the market, regarding image forming apparatuses such as printers, copiers and facsimiles. Accordingly, among electrophotographic toners (hereinafter also referred to simply as “toners”), those superior in low-temperature fixability are required and also those having properties such as offset resistance and heat-resistant storageability (blocking resistance) that are totally different from the low-temperature fixability are required. Regarding pulverized toners, in particular, there are more and more cases where polyester resins advantageous in terms of low-temperature fixability are used for toner binders; however, the pulverizability of these resins is often poor in comparison with that of styrene-acrylic resins conventionally used, so that there is a disadvantage in terms of reduction in particle diameter for improving productivity of toners and image quality.

A variety of ideas for solving such problems have been considered. For example, there has been reported a toner containing a nonlinear cross-linkage polyester resin in which a rosin is used as an acid component, which is claimed to be a toner capable of securing all of low-temperature fixability, hot offset resistance and heat-resistant storageability (refer to Japanese Patent Application Laid-Open (JP-A) No. 04-70765). Also, there have been known toners each containing a polyester resin which includes a refined rosin or an acid-modified rosin so as to solve problems of smell and improve heat-resistant storageability (refer to JP-A Nos. 2007-137910, 2007-292815 and 04-307557).

However, the polyester resins used in the toners are hard and brittle owing to the introduction of rosin skeletons, and so there is a problem in that the resins are superior in pulverizability but inferior in mechanical durability. Thus, there exist the following problems: toner powder breaks owing to stress caused by agitation inside developing devices, thereby degrading the functions of the toners; moreover, carriers and inner portions of the developing devices are smeared with broken fine toner powder, thereby noticeably decreasing developing capability.

Meanwhile, JP-A Nos. 2007-139811 and 2007-139812 each report a toner into which a refined rosin and a bisphenol A are introduced in view of improving the durability of the toner. However, these toners cannot sufficiently solve the above-mentioned problems.

For low-temperature fixation of a toner, a reduction in the melt viscosity of the toner is effective. Since such a toner easily causes hot offset, release oil such as silicone oil is often applied over a heat roll and the like.

However, the application of the release oil requires an oil tank and an oil applying device, which makes an apparatus complex and large in size, and also the oil often adheres to copy paper, film for an OHP (overhead projector), etc., thereby possibly causing problems in that writing capability with aqueous ink degrades, and the color tone degrades owing to the oil adhering to the OHP.

Accordingly, to prevent hot offset without applying release oil, a method of adding a release agent such as wax into toner is commonly used. In this case, the dispersed state of the release agent in the toner greatly influences the releasing effects of the release agent. Specifically, when the release agent is present in a binder resin in a compatible manner, its releasing capability cannot be exhibited, whereas when it is present as incompatible domain particles and seeps to the surface of the toner at the time of fixation, its releasing capability can be exhibited.

However, when the dispersion particle diameter of the release agent is too large, the proportion of the release agent (wax or the like) present in the vicinity of surfaces of toner particles relatively increases. Thus, there may exist the following problems: the release agent aggregates and thereby causes degradation of fluidity; an external additive added onto the surfaces of the toner particles is embedded in the particles, causing degradation of transfer capability and developing capability, and thus there is a decrease in image density; and, in long-term use, the release agent such as wax transfers to the photoconductor surface, preventing favorable image quality from being obtained as it causes filming, etc.

In an attempt to solve the above-mentioned problems, there has been proposed a method using as a binder resin a polyester resin obtained by condensation polymerization between an alcohol component and a carboxylic acid component (including a refined rosin) and also using a graft polymer composed of a polyolefin resin and a vinyl resin as well as using a release agent (refer to JP-A No. 2008-20631). The composition described in JP-A No. 2008-20631 makes it possible to satisfy required low-temperature fixability and offset resistance; however, the problem with mechanical durability derived from the rosin is not satisfactorily solved.

In recent times, as the field of print on demand (POD) has been developing, demands from the printing market with respect to toners have been heightening further. The electrophotographic POD system is advantageous in terms of printing a small number of sheets and performing variable printing and is eagerly expected to be an alternative technique in printing which does not involve complicated technology. On the other hand, the POD system is used in the printing market, so that the electrophotographic process needs to be achieved with a far longer lifetime than in offices and homes. Accordingly, in the case where the electrophotographic technology is applied to the POD system, toners which are superior in fixability even with a smaller amount of heat and which further reduce smearing of developing rollers, etc. are now demanded to adapt to higher linear velocity.

### BRIEF SUMMARY OF THE INVENTION

The present invention is aimed at solving the problems in related art and achieving the following object.

An object of the present invention is to provide a toner, a developer, an image forming method, a process cartridge, and a developer to be supplied, which secure all of low-temperature fixability, offset resistance (hot offset resistance) and heat-resistant storageability in a manner that is adaptable to an ultrahigh-speed image forming system, which yield superior smear-preventing capability of a developing roller, etc. in the ultrahigh-speed image forming system, and which secure stable image density over a long period of time.

As a result of carrying out earnest examinations, the present inventors have found that the above-mentioned problems can be solved by the inventions according to <1> to <20> below, upon which the present invention is based. The following specifically explains the present invention.

<1> A toner including: a binder resin containing at least a polyester resin (A) and a polyester resin (B) as main components; a colorant; a release agent; and a graft polymer containing a polyolefin resin and a vinyl resin, wherein the polyester resin (A) is a condensation product resulting from condensation polymerization between an alcohol component containing a dihydric alcohol compound, and a carboxylic acid component containing a rosin compound, and the rosin compound occupies 5% by mass or more of the total amount of the alcohol component and the carboxylic acid component, and wherein the polyester resin (B) is a condensation product resulting from condensation polymerization between an alcohol component containing a dihydric alcohol compound which includes at least an alkylene oxide adduct of a bisphenol compound represented by General Formula (1) below, and a carboxylic acid component:

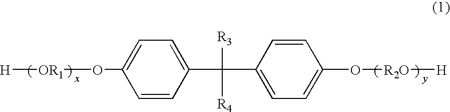

where R₁ and R₂ each denote an alkylene group having two to four carbon atoms, R₃ and R₄ each denote any one of a hydrogen atom, a straight-chain alkyl group having one to six carbon atoms, and a branched alkyl group having one to six carbon atoms, x and y each denote an integer of zero or greater, and the sum of x and y is in the range of 1 to 16.

<2> The toner according to <1>, wherein the rosin compound occupies 25% by mass to 40% by mass of the total amount of the alcohol component and the carboxylic acid component.
<3> The toner according to <1> or <2>, wherein the dihydric alcohol compound contained in the alcohol component used in the condensation polymerization for the polyester resin (A) contains an aliphatic diol, and the aliphatic diol occupies 65% by mole or more of the dihydric alcohol compound.
<4> The toner according to <3>, wherein the dihydric alcohol compound contained in the alcohol component used in the condensation polymerization for the polyester resin (A) contains an aliphatic diol, and the aliphatic diol occupies 80% by mole to 100% by mole of the dihydric alcohol compound.
<5> The toner according to <3>, wherein the aliphatic diol is 1,2-propanediol.
<6> The toner according to any one of <1> to <5>, wherein the carboxylic acid component used in the condensation polymerization for the polyester resin (A) contains an aromatic dicarboxylic acid compound.
<7> The toner according to <6>, wherein the aromatic dicarboxylic acid compound is terephthalic acid.
<8> The toner according to any one of <1> to <7>, wherein the dihydric alcohol compound contained in the alcohol component used in the condensation polymerization for the polyester resin (B) occupies 80% by mole or more of the alcohol component.
<9> The toner according to any one of <1> to <8>, wherein the polyester resin (A) has an acid value of 25 mg KOH/g to 70 mg KOH/g, and the polyester resin (B) has an acid value of 1 mg KOH/g to 25 mg KOH/g.
<10> The toner according to any one of <1> to <9>, wherein the mass ratio of the polyester resin (B) to the polyester resin (A), represented by (B)/(A), is in the range of 1/9 to 6/4.
<11> The toner according to any one of <1> to <10>, wherein the mass ratio of the polyester resin (B) to the polyester resin (A), represented by (B)/(A), is 1/1.
<12> The toner according to any one of <1> to <11>, wherein the polyolefin resin is polyethylene, and the vinyl resin is at least one selected from styrene, acrylonitrile, butyl acrylate and acrylic acid.
<13> The toner according to any one of <1> to <12>, wherein the alkylene oxide adduct of the bisphenol compound represented by General Formula (1) is one of a bisphenol A propylene oxide adduct and a bisphenol F propylene oxide adduct.
<14> The toner according to any one of <1> to <13>, wherein the release agent is a paraffin wax.
<15> A developer including the toner according to any one of <1> to <14>, and a carrier.
<16> An image forming method including charging a surface of a latent electrostatic image bearing member by means of a charging unit; forming a latent electrostatic image on the surface of the latent electrostatic image bearing member by means of an exposing unit; developing the latent electrostatic image as a toner image by means of a developing unit, using a toner; transferring the toner image to a recording medium by means of a transfer unit; and fixing the transferred toner image by means of a fixing unit, wherein the toner is the toner according to any one of <1> to <14>.
<17> An image forming method including charging a surface of a latent electrostatic image bearing member by means of a charging unit; forming a latent electrostatic image on the surface of the latent electrostatic image bearing member by means of an exposing unit; developing the latent electrostatic image as a toner image by means of a developing unit, using a developer which includes a toner and a carrier; transferring the toner image to a recording medium by means of a transfer unit; and fixing the transferred toner image by means of a fixing unit, wherein the developer is the developer according to <15>.
<18> A process cartridge detachably mountable to an image forming apparatus main body, including a latent electrostatic image bearing member; and at least one unit selected from a charging unit configured to charge a surface of the photoconductor, an exposing unit configured to expose the charged surface of the photoconductor so as to form a latent electrostatic image, a developing unit which houses a toner and is configured to develop the formed latent electrostatic image with the use of the toner, a transfer unit configured to transfer the developed toner image, and a cleaning unit configured to remove the toner remaining on the surface of the photoconductor after the transfer, the latent electrostatic image bearing member and the at least one unit being provided in a unified manner, wherein the toner is the toner according to any one of <1> to <14>.
<19> A process cartridge detachably mountable to an image forming apparatus main body, including a latent electrostatic image bearing member; and at least one unit selected from a charging unit configured to charge a surface of the photoconductor, an exposing unit configured to expose the charged surface of the photoconductor so as to form a latent electrostatic image, a developing unit which houses a developer and is configured to develop the formed latent electrostatic image with the use of the developer which includes a toner and a carrier, a transfer unit configured to transfer the developed toner image, and a cleaning unit configured to remove the toner remaining on the surface of the photoconductor after the transfer, the latent electrostatic image bearing member and the at least one unit being provided in a unified manner, wherein the developer is the developer according to <15>.
<20> A developer to be supplied, including the toner according to any one of <1> to <14>, and a carrier, wherein the amount of the toner is in the range of 2 parts by mass to 50 parts by mass with respect to 1 part by mass of the carrier.

According to the present invention, it is possible to provide a toner and a developer which secure all of low-temperature fixability, offset resistance (hot offset resistance) and heat-resistant storageability in a manner that is adaptable to an ultrahigh-speed image forming system, which yield superior smear-preventing capability of a developing roller, etc. in the ultrahigh-speed image forming system, and which secure stable image density over a long period of time. Therefore, the toner and the developer of the present invention can be suitably used in an image forming method employing an electrophotographic system (related, for example, to a copier, electrostatic printing, a printer, a facsimile, electrostatic recording, etc.), notably in a printing system adaptable to the field of electrophotographic print on demand (POD).

Regarding an image forming method of the present invention, since an image is developed using the toner or the developer, a high-quality stable image is formed even in an ultrahigh-speed image forming system.

Regarding a process cartridge of the present invention, since a developing unit which houses the toner or the developer is used and the toner is supplied from the developing unit, a stable image can be output even in an ultrahigh-speed image forming system, without causing abnormal image formation such as offset. Also, the process cartridge is superior in handleability, for example in terms of the fact that it can be quickly replaced.

Regarding a developer of the present invention to be supplied, the developer is composed of the toner and a carrier, and the developer is used in an image forming apparatus which forms images while allowing a surplus developer in a developing device to discharge. Thus, stable image quality can be obtained over a very long period of time. In other words, a carrier which has degraded in the developing device is replaced with a carrier which has not degraded and which is contained in the developer to be supplied, thereby making it possible to keep the charged amount stable over a long period of time and obtain a stable image.

### BRIEF DESCRIPTION OF THE DRAWINGS

FIG. 1 is a schematic cross-sectional view showing a structural example of a process cartridge according to the present invention.

FIG. 2 is a schematic cross-sectional view showing the structure of a developing device, in which a developer of the present invention to be supplied can be used, and the surroundings of the developing device.

### DETAILED DESCRIPTION OF THE INVENTION

### Toner

As described above, a toner of the present invention includes: a binder resin containing at least a polyester resin (A) and a polyester resin (B) as main components; a colorant; a release agent; and a graft polymer containing a polyolefin resin and a vinyl resin; wherein the polyester resin (A) is a condensation product resulting from condensation polymerization between an alcohol component containing a dihydric alcohol compound, and a carboxylic acid component containing a rosin compound, and the rosin compound occupies 5% by mass or more of the total amount of the alcohol component and the carboxylic acid component; and wherein the polyester resin (B) is a condensation product resulting from condensation polymerization between an alcohol component containing a dihydric alcohol compound which includes at least an alkylene oxide adduct of a bisphenol compound represented by General Formula (1) below, and a carboxylic acid component:

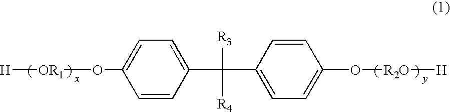

In General Formula (1), R₁ and R₂ each denote an alkylene group having two to four carbon atoms, R₃ and R₄ each denote any one of a hydrogen atom, a straight-chain alkyl group having one to six carbon atoms, and a branched alkyl group having one to six carbon atoms, x and y each denote an integer of zero or greater, and the sum of x and y is in the range of 1 to 16. Further, in General Formula (1), x and y are preferably positive integers, and the sum of x and y is preferably in the range of 2 to 16.

The toner of the present invention includes: a binder resin containing at least a polyester resin (A) and a polyester resin (B) as main components; a colorant; a release agent; and a graft polymer containing a polyolefin resin and a vinyl resin. If necessary, the toner may further include a charge controlling agent, an external additive and other component(s). The following explains the toner of the present invention in detail.

In the present invention, by using the polyester resin (A) and the polyester resin (B) in combination as the binder resin, it is possible to provide a toner and a developer using the toner, which secure all of low-temperature fixability, offset resistance (hot offset resistance) and heat-resistant storageability, yield superior pigment dispersibility, and further, yield superior smear-preventing capability of a developing roller, etc. in an ultrahigh-speed image forming system, and superior image density stability over a long period of time.

Although the whole mechanism is not yet clear, it is inferred that since the polyester resin (B) including a skeleton of a bisphenol compound with high mechanical strength is dispersed in a microphase-separated state in the polyester resin (A) which is a condensation product resulting from condensation polymerization between an alcohol component containing a dihydric alcohol compound and a carboxylic acid component containing a rosin compound (modified rosin or unmodified rosin), heat-resistant storageability and smear-preventing capability of the developing roller, etc. are improved by the polyester resin (B) including the skeleton of the bisphenol compound with high mechanical strength, while the superior fixability and pulverizability of the polyester resin (A) is maintained. Here, as to the carboxylic acid component, the rosin compound preferably occupies 5% by mass or more of the total amount of the alcohol component and the carboxylic acid component.

In other words, it is supposed that, by combining the polyester resin (A) and the polyester resin (B) as main components, the respective superior properties of these resins are exhibited in a well-balanced, complementary manner, which makes it possible to secure all of low-temperature fixability, offset resistance and heat-resistant storageability.

Functional effects of the present invention cannot be obtained by merely using as a binder resin a polyester resin which includes both a rosin skeleton and a bisphenol skeleton in one molecule.

The binder resin in the present invention contains at least the polyester resin (A) and the polyester resin (B) as main components; if necessary, the binder rein may further contain other resin(s) as long as the functional effects of the present invention are not impaired. The following explains the binder resin used as a constituent of the toner of the present invention.

### <Binder Resin>

### <<Polyester Resin (A)>>

The polyester resin (A), one of the main components of the binder resin, is a condensation product resulting from condensation polymerization between an alcohol component containing a dihydric alcohol compound, and a carboxylic acid component containing a rosin compound (modified rosin or unmodified rosin). Here, the amount of the rosin compound is adjusted so as to occupy 5% by mass or more of the total amount of the alcohol component and the carboxylic acid component. As just described, the introduction of a rosin skeleton into the polyester resin (A) makes it possible to exhibit superior fixability and pulverizability, and the use of the polyester resin (A) in combination with the polyester resin (B) makes it possible to obtain a toner superior in low-temperature fixability, hot offset resistance and heat-resistant storageability.

### —Alcohol Component—

As described above, the alcohol component of the polyester resin (A) contains the dihydric alcohol compound (diol); it should be noted that an aliphatic diol is preferable as this dihydric alcohol compound (diol). By using, for the alcohol component, an aliphatic diol that is superior in reactivity to aromatic alcohols, the rosin compound is incorporated as a skeleton of the polyester resin. Specifically, by adding the rosin compound and the aliphatic diol into the reaction system firstly to react the rosin compound and the aliphatic diol together, the rosin compound is incorporated into the polyester resin with greater ease.

The amount of the aliphatic diol in the dihydric alcohol compound (diol) contained in the alcohol component is preferably 65% by mole or more, more preferably in the range of 80% by mole to 100% by mole.

Examples of the aliphatic diol include ethylene glycol, 1,2-propanediol and 1,3-propanediol, with aliphatic alcohols which each have two to six carbon atoms being preferable in that the glass transition temperature of the resin can be kept high and storageability of the toner can be secured. These aliphatic alcohols may be used individually or in combination.

Among the aliphatic alcohols, 1,2-propanediol is preferable in that the glass transition temperature of the resin can be kept high and storage stability of the toner can be secured. Specifically, 1,2-propanediol that is an alcohol having a secondary hydroxyl group and three carbon atoms yields a great effect of preventing decrease in the glass transition temperature of the resin and decrease in the storageability of the toner, in comparison with alcohols each having secondary hydroxyl group(s) and four or more carbon atoms. The amount of 1,2-propanediol contained in the aliphatic diol is preferably 65% by mole or more, more preferably 70% by mole or more, even more preferably in the range of 80% by mole to 100% by mole.

In the case where an unmodified rosin compound is used as the after-mentioned rosin compound, it is preferred in terms of reactivity that, besides 1,2-propanediol, an aliphatic diol such as 1,3-propanediol, where both of the two hydroxyl groups are primary hydroxyl groups, be also contained in the aliphatic diol in the dihydric alcohol compound contained in the alcohol component. The amount of this aliphatic diol also contained in the aliphatic diol is 30% by mole or less, more preferably in the range of 10% by mole to 20% by mole.

Examples of dihydric alcohol compounds other than the aliphatic diols include aromatic alcohols such as alkylene oxide adducts of bisphenol A, exemplified by polyoxypropylene-2,2-bis(4-hydroxyphenyl)propane and polyoxyethylene-2,2-bis(4-hydroxyphenyl)propane; and hydrogenated bisphenol A, and alkylene (having two to four carbon atoms) oxide (average number of moles added: 1 to 16) adducts of the hydrogenated bisphenol A.

The amount of the dihydric alcohol compound contained in the alcohol component preferably ranges from 60% by mole to 100% by mole, more preferably from 60% by mole to 95% by mole, even more preferably from 65% by mole to 90% by mole.

### —Carboxylic Acid Component—

Rosin compounds usable in the present invention include both unmodified rosin compounds (unmodified rosins) and modified rosin compounds (modified rosins). Specifically, examples of the rosin compounds include tall rosins derived from tall oils obtained as by-products in processes of producing pulp; natural rosins classified broadly into gum rosins obtained from natural pine resins, wood rosins obtained from stumps of pines, and the like; rosin compounds such as modified rosins exemplified by isomerized rosins, dimerized rosins, polymerized rosins, disproportionated rosins and hydrogenated rosins; and rosins modified with unsaturated fatty acids. Preference is given to rosins modified with unsaturated fatty acids.

A rosin modified with an unsaturated fatty acid can be obtained by adding an unsaturated fatty acid to rosin for reaction.

Specifically, it can be obtained through the Diels-Alder reaction or ene reaction, with heating, between an unsaturated fatty acid and acid(s) having conjugated double bond(s) in main components of rosin, such as levopimaric acid, abietic acid, neoabietic acid, palustric acid, etc. Any of the above-mentioned rosins known in the art can be used as the rosin to be modified, with natural rosins being preferable in terms of color tone, and tall rosins being preferable in terms of low-temperature fixability.

Examples of the unsaturated fatty acid with which to modify the rosin include (meth)acrylic acid, maleic acid, maleic anhydride, fumaric acid and itaconic acid.

It is preferred in terms of low-temperature fixability, offset resistance and heat-resistant storageability that the amount of low-molecular-weight components which are 500 or less in molecular weight, accounted for by residual monomer and/or oligomer components, etc., occupy 12% by mass or less, more preferably 10% by mass or less, even more preferably 9% by mass or less, particularly preferably 8% by mass or less, of the polyester resin. The amount of the low-molecular-weight components can be calculated utilizing an area proportion regarding molecular weights, measured in accordance with the after-mentioned gel permeation chromatography (GPC).

The method for producing the rosin modified with the unsaturated fatty acid is not particularly limited and may be suitably selected according to the purpose. For example, a modified rosin can be obtained as follows: rosin and an unsaturated fatty acid are mixed together, which is followed by heating at 180° C. to 260° C., and the unsaturated fatty acid is added to acid(s) having conjugated double bond(s), contained in the rosin, by the Diels-Alder reaction or ene reaction. The modified rosin obtained may be used as it is, without any change to it, or may be used in a refined manner, for example by subjecting it to distillation.

The rosin compound occupies 5% by mass or more, preferably 5% by mass to 40% by mass, more preferably 10% by mass to 40% by mass, even more preferably 15% by mass to 40% by mass, particularly preferably 25% by mass to 40% by mass, of the total amount of the alcohol component and the carboxylic acid component.

As carboxylic acid components which may also be contained, besides the rosin compound, in the carboxylic acid component used for obtaining the polyester resin (A), aromatic dicarboxylic acid compounds such as phthalic acid, isophthalic acid and terephthalic acid are preferable in view of obtaining a resin having a high glass transition temperature. The amount of the aromatic dicarboxylic acid compound(s) contained is preferably in the range of 40 mol to 95 mol, more preferably 50 mol to 90 mol, even more preferably 60 mol to 80 mol, per 100 mol of the alcohol component. In the present invention, carboxylic acids, anhydrides of carboxylic acids, and alkyl esters of carboxylic acids are all referred to in the present specification as carboxylic acid compounds.

The alcohol component and the carboxylic acid component used for obtaining the polyester resin (A) may each contain trihydric/trivalent or higher monomer(s) as raw material(s).

The total amount of the trihydric/trivalent or higher monomer(s) contained is preferably 40 mol or less, more preferably in the range of 5 mol to 30 mol, per 100 mol of the dihydric alcohol compound.

Regarding the trihydric/trivalent or higher monomer(s), preferred examples of trivalent or higher carboxylic acid compounds include trimellitic acid and derivatives thereof, and examples of trihydric or higher alcohols include glycerin, pentaerythritol, trimethylolpropane, sorbitol, and alkylene (having two to four carbon atoms) oxide adducts (average number of moles added: 1 to 16) of these, with glycerin being particularly preferable for its effectiveness in improving low-temperature fixability.

### <<Polyester Resin (B)>>

By using the polyester resin (B) in addition to the above-mentioned polyester resin (A) for the binder resin of the toner used in the present invention, respective effects of the resins are synergistically produced, and thus effects of the present invention are exhibited in an optimized manner.

As described above, the polyester resin (B) is a condensation product resulting from condensation polymerization between an alcohol component containing a dihydric alcohol compound which includes at least an alkylene oxide adduct of a bisphenol compound represented by General Formula (1) above, and a carboxylic acid component.

### —Alcohol Component—

Examples of the alkylene oxide adduct of the bisphenol compound represented by General Formula (1) above, included in the dihydric alcohol compound used for the alcohol component in the condensation polymerization for obtaining the polyester resin (B), include diols obtained by polymerization between bisphenol A, bisphenol F, etc. and cyclic ethers such as ethylene oxide and propylene oxide.

The alcohol component of the polyester resin (B) may also include alcohol(s) besides the alkylene oxide adduct of the bisphenol compound represented by General Formula (1) above as long as the object and the functional effects of the present invention are not impaired. It should, however, be noted that the alkylene oxide adduct of the bisphenol compound represented by General Formula (1) above preferably occupies 80% by mole or more of the dihydric alcohol compound.

### —Carboxylic Acid Component—

The carboxylic acid component used in the condensation polymerization for obtaining the polyester resin (B) is not particularly limited and may be suitably selected from divalent carboxylic acids and trivalent or higher carboxylic acids according to the purpose.

Examples of the divalent carboxylic acids include benzenedicarboxylic acids such as phthalic acid, isophthalic acid and terephthalic acid, and anhydrides thereof; alkyldicarboxylic acids such as succinic acid, adipic acid, sebacic acid and azelaic acid, and anhydrides thereof; unsaturated dibasic acids such as maleic acid, citraconic acid, itaconic acid, alkenylsuccinic acid, fumaric acid and mesaconic acid; and unsaturated dibasic acid anhydrides such as maleic acid anhydride, citraconic acid anhydride, itaconic acid anhydride and alkenylsuccinic acid anhydride.

Examples of the trivalent or higher carboxylic acids include trimellitic acid, pyromellitic acid, 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, tetra(methylenecarboxy)methane, 1,2,7,8-octanetetracarboxylic acid and Empol trimer acid; and anhydrides and partially lower alkylesters of these compounds.

Among these, inclusion of aromatic polyvalent carboxylic acid(s) such as phthalic acid, isophthalic acid, terephthalic acid, trimellitic acid, etc. be preferable in terms of heat-resistant storageability and mechanical strength of the resin. It is preferred that the aromatic polyvalent carboxylic acid(s) occupy 40% by mole to 95% by mole, more preferably 50% by mole to 90% by mole, even more preferably 60% by mole to 80% by mole, of the carboxylic acid component.

### —Esterification Catalyst—

Each of the condensation polymerizations between the alcohol components and the carboxylic acid components for the polyester resins (A) and (B) is preferably performed in the presence of an esterification catalyst.

Examples of the esterification catalyst include Lewis acids such as p-toluenesulfonic acid, titanium compounds, and tin (II) compounds which do not have the Sn—C bond. These may be used individually or in combination. In the present invention, titanium compounds, and/or tin (II) compounds which do not have the Sn—C bond are preferable.

Regarding the titanium compounds, preference is given to titanium compounds having the Ti—O bond, and greater preference is given to compounds each having 1 to 28 carbon atoms in total and each having an alkoxy group, an alkenyloxy group or an acyloxy group.

Specific examples of the titanium compounds include titanium diisopropylate bistriethanolaminate [Ti(C₆H₁₄O₃N)₂(C₃H₇O)₂], titanium diisopropylate bisdiethanolaminate [Ti(C₄H₁₀O₂N)₂(C₃H₇O)₂], titanium dipentylate bistriethanolaminate [Ti(C₆H₁₄O₃N)₂(C₅H₁₁O)₂], titanium diethylate bistriethanolaminate [Ti(C₆H₁₄O₃N)₂(C₂H₅O)₂], titanium dihydroxyoctylate bistriethanolaminate [Ti(C₆H₁₄O₃N)₂(OHC₈H₁₆O)₂], titanium distearate bistriethanolaminate [Ti(C₆H₁₄O₃N)₂(C₁₈H₃₇O)₂], titanium triisopropylate triethanolaminate [Ti(C₆H₁₄O₃N)₁(C₃H₇O)₃] and titanium monopropylate tris(triethanolaminate) [Ti(C₆H₁₄O₃N)₃(C₃H₇O)₁]. Among these, titanium diisopropylate bistriethanolaminate, titanium diisopropylate bisdiethanolaminate and titanium dipentylate bistriethanolaminate are preferable, and these compounds can, for example, be obtained as commercially available products manufactured by Matsumoto Trading Co., Ltd.

Other preferred examples of the titanium compounds include tetra-n-butyl titanate [Ti(C₄H₉O)₄], tetrapropyl titanate [Ti(C₃H₇O)₄], tetrastearyl titanate [Ti(C₁₈H₃₇O)₄], tetramyristyl titanate [Ti(C₁₄H₂₉O)₄], tetraoctyl titanate [Ti(C₈H₁₇O)₄], dioctyl dihydroxyoctyl titanate [Ti(C₈H₁₇O)₂(OHC₈H₁₆O)₂] and dimyristyldioctyl titanate [Ti(C₁₄H₂₉O)₂(C₈H₁₇O)₂]. Among these, tetrastearyl titanate, tetramyristyl titanate, tetraoctyl titanate and dioctyl dihydroxyoctyl titanate are preferable. For example, these can be obtained by reacting halogenated titanium with corresponding alcohols or can be obtained as commercially available products manufactured by Nisso, etc.

The amount of any of the titanium compounds present is preferably in the range of 0.01 parts by mass to 1.0 part by mass, more preferably 0.1 parts by mass to 0.7 parts by mass, per 100 parts by mass as the total amount of the alcohol component and the carboxylic acid component.

Regarding the tin (II) compounds which do not have the Sn—C bond, preference is given to tin (II) compounds which have the Sn—O bond, tin (II) compounds which have the Sn—X bond (X denotes any halogen atom), and the like, particularly tin (II) compounds which have the Sn—O bond.

Examples of the tin (II) compounds which have the Sn—O bond include tin (II) carboxylates each having a carboxylic acid group with 2 to 28 carbon atoms, such as tin (II) oxalate, tin (II) diacetate, tin (II) dioctanoate, tin (II) dilaurate, tin (II) distearate and tin (II) dioleate; dialkoxy tins (II) each having an alkoxy group with 2 to 28 carbon atoms, such as dioctyloxy tin (II), dilauroxy tin (II), distearoxy tin (II) and dioleyloxy tin (II); tin (II) oxide; and tin (II) sulfate. Examples of the tin (II) compounds which have the Sn—X bond (X denotes any halogen atom) include tin (II) halides such as tin (II) chloride and tin (II) bromide. Among these, in terms of catalytic capability and effects of a rise in charge, fatty acid tins (II) represented by (R¹COO)₂Sn (where R¹ denotes an alkyl or alkenyl group having 5 to 19 carbon atoms), dialkoxy tins (II) represented by (R²⁰)₂Sn (where R² denotes an alkyl or alkenyl group having 6 to 20 carbon atoms), and tin (II) oxide represented by SnO are desirable, fatty acid tins (II) represented by (R¹COO)₂Sn and tin (II) oxide are more desirable, and tin (II) dioctanoate, tin (II) distearate and tin (II) oxide are even more desirable.

The amount of any of the tin (II) compounds present is preferably in the range of 0.01 parts by mass to 1.0 part by mass, more preferably 0.1 parts by mass to 0.7 parts by mass, per 100 parts by mass as the total amount of the alcohol component and the carboxylic acid component.

In the case where the titanium compound(s) and the tin (II) compound(s) are used in combination, the total amount of the titanium compound(s) and the tin (II) compound(s) present is preferably in the range of 0.01 parts by mass to 1.0 part by mass, more preferably 0.1 parts by mass to 0.7 parts by mass, per 100 parts by mass as the total amount of the alcohol component and the carboxylic acid component.

The condensation polymerization between the alcohol component and the carboxylic acid component may, for example, be performed in the presence of the esterification catalyst at a temperature of 180° C. to 250° C. in an inert gas atmosphere.

In the present invention, a more preferred condition with which to secure all of low-temperature fixability, offset resistance (hot offset resistance) and heat-resistant storageability is that the mass ratio (B)/(A) of the polyester resin (B) to the polyester resin (A) is in the range of 1/9 to 6/4.

In view of fixability, heat-resistant storageability and durability, it is preferred that the glass transition temperatures of the polyester resin (A) and the polyester resin (B) be in the range of 45° C. to 75° C., more preferably 50° C. to 70° C.

In view of fixability, storageability and durability, it is preferred that the softening point of the polyester resin (B) be in the range of 90° C. to 160° C., more preferably 95° C. to 155° C., even more preferably 100° C. to 150° C.

The acid values of the polyester resin (A) and the polyester resin (B) are preferably in the range of 1 mg KOH/g to 70 mg KOH/g; especially when the acid value of the polyester resin (A) is in the range of 25 mg KOH/g to 70 mg KOH/g and the acid value of the polyester resin (B) is in the range of 1 mg KOH/g to 25 mg KOH/g, the dispersed state of the resins and the release agent is optimized.

In the present invention, the term “polyester resin” means a resin including a polyester unit (i.e. a site having a polyester structure), obtained by condensation polymerization between an alcohol component and a carboxylic acid component. As described above, the polyester resin (A) is a condensation product resulting from condensation polymerization between an alcohol component containing a dihydric alcohol compound, and a carboxylic acid component containing a rosin compound, while the polyester resin (B) is a condensation product resulting from condensation polymerization between an alcohol component containing a dihydric alcohol compound which includes at least an alkylene oxide adduct of a bisphenol compound represented by General Formula (1) above, and a carboxylic acid component. Here, it should be noted that the polyester resins (A) and (B) may contain polyesters modified to such an extent that the properties of the polyester resins (A) and (B) are not substantially impaired.

Also in the present invention, the polyester resin (A) and the polyester resin (B) are preferably amorphous resins as opposed to crystalline resins. In the present specification, “amorphous resin” means a resin wherein the difference between the softening point of the resin and the glass transition temperature (Tg) of the resin is 30° C. or greater.

It should be noted that, in the present invention, resin(s) other than the polyester resins (A) and (B) may also be contained in the binder resin as long as the effects of the present invention are not impaired.

Examples of such resin(s) include binder resins known in the art, including polyester resins, vinyl resins such as styrene-acrylic resin, epoxy resins, polycarbonates, polyurethanes, and composite resins (otherwise called “hybrid resins”) each having two or more resin units including a polyester unit.

### <Graft Polymer>

The graft polymer used as a constituent of the toner in the present invention has a structure in which a polyolefin resin is grafted with at least a vinyl resin, and the graft polymer may be produced in accordance with a conventionally known method. Specifically, a polyolefin resin constituting a main chain of the graft copolymer is dissolved in organic solvent, vinyl monomer(s) for a vinyl resin constituting a side chain of the graft polymer is/are added to the obtained solution, and the polyolefin resin and the vinyl monomer(s) are subjected to graft polymerization reaction in the organic solvent in the presence of a polymerization initiator such as an organic peroxide.

In view of filming prevention, the mass ratio of the polyolefin resin to the vinyl monomer(s) (polyolefin resin:vinyl monomer(s)) is preferably 1 to 30:70 to 99, more preferably 2 to 27:83 to 98.

An unreacted polyolefin resin, and an ungrafted vinyl resin produced by polymerization between vinyl monomers are mixed in the graft polymer (in such a manner as to form a mixed resin), obtained by the graft polymerization; in the present invention, it is not that the unreacted polyolefin resin and the ungrafted vinyl resin in the mixed resin need to be separated and removed from the graft polymer, but that the graft polymer can be favorably used as a mixed resin containing these.

The unreacted polyolefin resin occupies 5% by mass or less, preferably 3% by mass or less, of the mixed resin. The ungrafted vinyl resin occupies 10% by mass or less, preferably 5% by mass or less, of the mixed resin. Therefore, the graft polymer occupies 85% by mass or more, preferably 90% by mass or more, of the mixed resin.

In the mixed resin, the proportions and molecular weights of the graft polymer resins, the molecular weight of the vinyl polymer, etc. may be suitably adjusted according to conditions such as the proportions of reactive raw materials used, the polymerization reaction temperature and the reaction time.

Regarding the release agent that is a constituent of the toner of the present invention, at least part of the release agent is enveloped in the graft polymer or attached to the graft polymer.

Specifically, the graft polymer suppresses movement and reaggregation of the finely prepared release agent in a toner composition solution obtained by dissolving or dispersing the toner composition which contains the release agent and the graft polymer and thusly liquefying the toner composition. It is inferred that this is because the polyolefin resin of the graft polymer has a high affinity for the release agent, and the vinyl resin of the graft polymer has a high affinity for the binder resin (binder resin containing at least the polyester resins (A) and (B) as main components), thereby producing effects such as of a dispersant.

Examples of olefins for the polyolefin resin include ethylene, propylene, 1-butene, isobutylene, 1-hexene, 1-dodecene and 1-octadecene.

Examples of the polyolefin resin include polymers of olefins, thermally degraded products of polymers of olefins, oxides of polymers of olefins, modified products of polymers of olefins, and copolymers of olefins and other monomers copolymerizable with the olefins.

Examples of the polymers of olefins include polyethylene, polypropylene, ethylene-propylene copolymer, ethylene-1-butene copolymer and propylene-1-hexene copolymer.

Examples of the oxides of polymers of olefins include oxides of the above-mentioned polymers of olefins shown as examples.

The thermally degraded products of polymers of olefins are polyolefin reins obtained by heating polyolefin resins of 50,000 to 5,000,000 in weight average molecular weight to between 250° C. and 450° C. for reduction in their molecular weights. The double bond content per molecule, the number of molecules being calculated from the number average molecular weight, after the thermal degradation, is preferably in the range of 30% to 70%.

Examples of the modified products of polymers of olefins include maleic acid derivative adducts of the above-mentioned polymers of olefins shown as examples. Examples of the maleic acid derivative adducts include maleic anhydride, monomethyl maleate, monobutyl maleate and dimethyl maleate.

Examples of the copolymers of olefins and other monomers copolymerizable with the olefins include copolymers of olefins and monomers such as unsaturated carboxylic acids and unsaturated carboxylic acid alkyl esters. Examples of the unsaturated carboxylic acids include (meth)acrylic acid, itaconic acid and maleic anhydride. Examples of the unsaturated carboxylic acid alkyl esters include (meth)acrylic acid alkyl esters each having 1 to 18 carbon atoms, and maleic acid alkyl esters each having 1 to 18 carbon atoms.

Polyolefin resin usable in the present invention are satisfactory as long as their structures as polymers have polyolefin structures, and it should be noted that monomers constituting the polyolefin resins do not necessarily have olefin structures. Accordingly, for instance, polymethylene such as Sasol Wax may also be used.

Among these polyolefin resins, polymers of olefins, thermally degraded polyolefins, oxides of polymers of olefins, and modified products of polymers of olefins are desirable, polyethylene, polymethylene, polypropylene, ethylene-propylene copolymer, thermally degraded products of these compounds, oxidized polyethylene, oxidized polypropylene, maleinated polypropylene and the like are more desirable, and polyethylene and thermally degraded products of polypropylene are particularly desirable.

The softening point of the polyolefin resin is generally in the range of 60° C. to 170° C., which improves the fluidity of the toner, and it is preferred that the softening point be in the range of 70° C. to 150° C. in terms of effectively exhibiting releasing effects.

In terms of preventing filming to a carrier, etc. and improving releasing capability, the number average molecular weight of the polyolefin resin generally ranges from 500 to 20,000, preferably from 1,000 to 15,000, particularly preferably from 1,500 to 10,000, and the weight average molecular weight of the polyolefin resin generally ranges from 800 to 100,000, preferably from 1,500 to 60,000, particularly preferably from 2,000 to 30,000.

As the vinyl resin, a homopolymer of a conventionally known vinyl monomer or a copolymer of conventionally known vinyl monomers may be used. Specific examples of monomers usable to form the vinyl resin include styrene monomers, alkyl esters of unsaturated carboxylic acids each having 1 to 18 carbon atoms, vinyl ester monomers, vinyl ether monomers, vinyl monomers containing halogen elements, diene monomers, and unsaturated nitrile monomers such as (meth)acrylonitrile and cyanostyrene. These may be used individually or in combination.

Examples of the styrene monomers include styrene, α-methylstyrene, p-methylstyrene, m-methylstyrene, p-methoxystyrene, p-hydroxystyrene, p-acetoxystyrene, vinyltoluene, ethylstyrene, phenylstyrene and benzylstyrene.

Examples of the alkyl esters of unsaturated carboxylic acids each having 1 to 18 carbon atoms include methyl (meth)acrylate, ethyl (meth)acrylate, butyl (meth)acrylate and 2-ethylhexyl (meth)acrylate.

Examples of the vinyl ester monomers include vinyl acetate.

Examples of the vinyl ether monomers include vinyl methyl ether.

Examples of the vinyl monomers containing halogen elements include vinyl chloride.

Examples of the diene monomers include butadiene and isobutylene.

Among these, styrene monomers, alkyl esters of unsaturated carboxylic acids, (meth)acrylonitrile, and combinations thereof are preferable, and styrene, and combinations of styrene and (meth)acrylic acid alkyl esters or (meth)acrylonitrile are particularly preferable.

The SP value (solubility parameter value) of the vinyl resin is preferably in the range of 10.0 (cal/cm³)^{1/2} to 11.5 (cal/cm³)^{1/2}. The SP value of the vinyl resin is adjusted in view of the SP value of the binder resin. Here, the SP value can be calculated in accordance with the Fedors method known in the art.

The number average molecular weight of the vinyl resin generally ranges from 1,500 to 100,000, preferably from 2,500 to 50,000, particularly preferably from 2,800 to 20,000, and the weight average molecular weight of the vinyl resin generally ranges from 5,000 to 200,000, preferably from 6,000 to 100,000, particularly preferably from 7,000 to 50,000.

In view of storageability and low-temperature fixability, the Tg (glass transition temperature) of the vinyl resin generally ranges from 40° C. to 90° C., preferably from 45° C. to 80° C., particularly preferably from 50° C. to 70° C.

Specific examples of the graft polymer in the present invention include graft polymers which are each composed of a polyolefin resin (a) and a vinyl resin (b) shown below.

(a): oxidized polypropylene, (b): styrene-acrylonitrile copolymer
(a): polyethylene-polypropylene mixture, (b): styrene-acrylonitrile copolymer
(a): ethylene-propylene copolymer, (b): styrene-acrylic acid-butyl acrylate copolymer
(a): polypropylene, (b): styrene-acrylonitrile-butyl acrylate-monobutyl maleate copolymer
(a): maleic acid-modified polypropylene, (b): styrene-acrylonitrile-acrylic acid-butyl acrylate copolymer
(a): maleic acid-modified polypropylene, (b): styrene-acrylonitrile-acrylic acid-2-ethylhexyl acrylate copolymer
(a): polyethylene-maleic acid-modified polypropylene mixture, (b): acrylonitrile-butyl acrylate-styrene-monobutyl maleate copolymer

Examples of methods for producing the graft polymer include a method in which a wax such as a polyolefin resin is dissolved or dispersed in a solvent such as toluene or xylene, this solution is heated to between 100° C. and 200° C., then vinyl monomer(s) is/are applied dropwise along with a peroxide-based initiator to effect polymerization, and subsequently the solvent is distilled away, thereby obtaining a graft polymer. Examples of the peroxide-based initiator include benzoyl peroxide, ditertiary butyl peroxide and tertiary butyl peroxide benzoate.

The amount of the peroxide-based initiator may be suitably adjusted based upon the masses of raw materials to be reacted together, and it generally ranges from 0.2% by mass to 10% by mass, preferably from 0.5% by mass to 5% by mass.

As described above, an unreacted polyolefin resin, and an ungrafted vinyl resin produced by polymerization between vinyl monomers may be mixed in the graft polymer. In the present invention, it is not that this unreacted polyolefin resin and this ungrafted vinyl resin need to be separated and removed from the graft polymer, but that the graft polymer can be favorably used as a mixed resin containing these.

The amounts of the components constituting the graft polymer may be suitably adjusted based upon the mass of the graft polymer produced. The amount of the polyolefin resin generally ranges from 1% by mass to 90% by mass, preferably from 5% by mass to 80% by mass. The amount of the vinyl resin generally ranges from 10% by mass to 99% by mass, preferably from 20% by mass to 95% by mass.

It is preferred in terms of dispersion stability of the release agent that the amount of the graft polymer, which includes the unreacted polyolefin resin and the ungrafted vinyl resin, generally range from 5 parts by mass to 300 parts by mass, preferably from 10 parts by mass to 150 parts by mass, per 100 parts by mass of the release agent.

### <Release Agent>

The release agent used as a constituent of the toner of the present invention is not particularly limited and may be suitably selected from release agents known in the art, according to the purpose; however, the release agent is particularly preferably a wax. Examples of the wax include aliphatic hydrocarbon waxes such as low-molecular-weight polyethylene, low-molecular-weight polypropylene, polyolefin waxes, microcrystalline waxes, paraffin waxes and Sasol Wax; oxides of aliphatic hydrocarbon waxes such as oxidized polyethylene wax, and block copolymers thereof; vegetable waxes such as candelilla wax, carnauba wax, rice wax, Japan wax and jojoba wax; animal waxes such as bees wax, lanolin and whale wax; mineral waxes such as ozokerite, ceresin and petrolatum; waxes composed mainly of fatty acid esters, such as montanic acid ester wax and castor wax; and partially or fully deoxidized fatty acid esters, such as deoxidized carnauba wax.

Examples of the release agent further include saturated straight-chain fatty acids such as palmitic acid, stearic acid, montanic acid, and straight-chain alkylcarboxylic acids having straight-chain alkyl groups; unsaturated fatty acids such as prandin acid, eleostearic acid and parinaric acid; saturated alcohols such as stearyl alcohol, eicosyl alcohol, behenyl alcohol, carnaubyl alcohol, ceryl alcohol, mesilyl alcohol and long-chain alkyl alcohols; polyhydric alcohols such as sorbitol; fatty acid amides such as linoleic acid amide, olefinic acid amide and lauric acid amide; saturated fatty acid bisamides such as methylenebiscapric acid amide, ethylenebislauric acid amide and hexamethylenebisstearic acid amide; unsaturated fatty acid amides such as ethylenebisoleic acid amide, hexamethylenebisoleic acid amide, N,N′-dioleyladipic acid amide and N,N′-dioleylsebacic acid amide; aromatic bisamides such as m-xylenebisstearic acid amide and N,N′-distearylisophthalic acid amide; fatty acid metal salts such as calcium stearate, calcium laurate, zinc stearate and magnesium stearate; waxes obtained by grafting aliphatic hydrocarbon waxes with vinyl monomers such as styrene and acrylic acid; partially esterified compounds composed of polyhydric alcohols and fatty acids such as monoglyceride behenate; and methylesterified compounds having hydroxyl groups obtained by hydrogenating vegetable oils.

Examples of the release agent further include polyolefins obtained by radical polymerization of olefins under high pressure, polyolefins obtained by refining low-molecular-weight by-products produced at the time of polymerization for high-molecular-weight polyolefins, polyolefins obtained by polymerization under low pressure using a catalyst such as a Ziegler catalyst or metallocene catalyst, polyolefins obtained by polymerization utilizing a radiant ray, an electromagnetic wave or light, low-molecular-weight polyolefins obtained by thermally decomposing high-molecular-weight polyolefins, paraffin waxes, microcrystalline waxes, Fischer-Tropsch wax, synthetic hydrocarbon waxes synthesized in accordance with the Synthol method, Hydrocol method, Arge method, etc., synthetic waxes each containing as a monomer a compound which has one carbon atom, hydrocarbon waxes each having a functional group such as hydroxyl group or carboxyl group, mixtures which are each composed of a hydrocarbon wax and a functional group-containing hydrocarbon wax, and waxes produced by graft-modifying these waxes with vinyl monomers such as styrene, maleic acid ester, acrylate, methacrylate and maleic anhydride.

Further, the following can also be favorably used: the above-mentioned release agents made to have sharp molecular weight distributions, using a press sweating method, a solvent method, a recrystallization method, a vacuum distillation method, a supercritical gas extraction method or a solution crystallization method; and the above-mentioned release agents from which low-molecular-weight solid fatty acids, low-molecular-weight solid alcohols, low-molecular-weight solid compounds and/or other impurities have been removed.

Especially in the case of a toner produced by a pulverization method, pulverization easily takes place at the interface between a binder resin and a release agent, and thus there is a problem in that the release agent is exposed at the toner surface, causing filming to a photoconductor, a carrier, etc. Regarding the binder resin in the present invention, however, it can yield excellent dispersion of the release agent, and the compatibilizing effects of the binder resin and the release agent make it difficult for the release agent to detach from the toner. Thus, the incidence of filming regarding the toner of the present invention is very low in comparison with conventional toners. Among the above-mentioned release agents, greater preference is given to carnauba wax and rice wax because these exhibit most favorable dispersibility with respect to the binder resin used in the present invention. As to the carnauba wax, carnauba wax from which a free fatty acid has been desorbed is particularly preferable.

In view of securing a favorable balance between fixability and offset resistance (hot offset resistance), it is preferred that the melting point of the release agent be in the range of 60° C. to 120° C., more preferably 70° C. to 110° C. When the melting point is lower than 60° C., there may be a decrease in blocking resistance. When the melting point is higher than 120° C., effects of resisting offset may be exhibited with difficulty.

Also, by using two or more different types of release agents together, plasticizing effects and releasing effects, which are effects produced by the release agents, can be exhibited at the same time. Examples of release agents with plasticizing effects include release agents having low melting points, release agents having branched chains in their molecular structures, and release agents having polar groups in their molecular structures. Examples of release agents with releasing effects include release agents having high melting points, which have molecular structures including straight chains or nonpolar structures without functional groups. Use examples thereof include use of a combination of two or more different types of release agents whose melting points are different from each other by 10° C. to 100° C., and use of a combination of a polyolefin and a graft-modified polyolefin.

In the case where two types of release agents are selected and these release agents have similar structures, relatively speaking, the release agent having a low melting point exhibits plasticizing effects and the release agent having a high melting point exhibits releasing effects. Here, when these melting points are different from each other by 10° C. to 100° C., the plasticizing effects and the releasing effects are exhibited in a separate manner, and so-called functional separation is effectively performed. When the difference in melting point is smaller than 10° C., functional separation may not be effectively performed. When the difference in melting point is greater than 100° C., it may be difficult to heighten the functions derived from the interacting effects. Here, at least one of the release agents preferably has a melting point of 60° C. to 120° C., more preferably 70° C. to 110° C., because functional separation effects tend to be easily produced.

Regarding the above-mentioned release agents, relatively speaking, those having branched structures, those having polar groups such as functional groups and those modified with components different from their main components exhibit plasticizing effects, whereas those having straight-chain structures, those having nonpolar structures without functional groups and those which are unmodified and have straight structures exhibit releasing effects.

Preferred examples of combinations of release agents include a combination of a polyethylene homopolymer/copolymer composed mainly of ethylene, and a polyolefin homopolymer/copolymer composed mainly of olefin(s) other than ethylene; a combination of a polyolefin and a graft-modified polyolefin; a combination of a hydrocarbon wax and an alcohol wax, a fatty acid wax or an ester wax; a combination of Fischer-Tropsch wax or a polyolefin wax, and a paraffin wax or a microcrystalline wax; a combination of Fischer-Tropsch wax and a polyolefin wax; a combination of a paraffin wax and a microcrystalline wax; and a combination of a hydrocarbon wax and carnauba wax, candelilla wax, rice wax or montan wax.

In either case, it is preferred that, regarding an endothermic peak observed in a DSC measurement of a toner, the peak top temperature of the maximum peak exist in the temperature range of 60° C. to 120° C., and more preferred that the maximum peak exist in the temperature range of 70° C. to 110° C., since a favorable balance between fixability and storageability of the toner can be easily secured.

In the present invention, the melting point of the release agent is defined as the peak top temperature of the maximum peak regarding an endothermic peak of the release agent (wax) measured in DSC.

Here, the melting point of the release agent or the toner is calculated from a DSC curve measured using differential scanning calorimeters (TA-60WS and DSC-60, manufactured by SHIMADZU CORPORATION) as DSC measuring apparatuses. The measuring method is based upon ASTM D3418-82. As for the DSC curve, the temperature is increased and decreased once for prerecording, then the temperature is increased at a temperature rate of 10° C./min and, while doing so, the DSC curve is measured, which is employed as the DSC curve for use in the present invention.

The amount of the release agent contained in the toner is not particularly limited and may be suitably selected according to the purpose. When the amount of the release agent is in the range of 0.2 parts by mass to 30 parts by mass per 100 parts by mass of the binder resin, a favorable dispersed state can be obtained. The amount of the release agent is preferably in the range of 1 part by mass to 20 parts by mass, more preferably 3 parts by mass to 15 parts by mass, per 100 parts by mass of the binder resin.

### <Colorant>

The colorant used as a constituent of the toner of the present invention is not particularly limited, and may be suitably selected from dyes and pigments known in the art, according to the purpose. Examples thereof include carbon blacks, nigrosine dyes, iron black, Naphthol Yellow S, Hansa Yellow (10G, 5G, G), cadmium yellow, yellow iron oxide, yellow ocher, yellow lead, titanium yellow, polyazo yellow, oil yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, Anthrazane Yellow BGL, isoindolinone yellow, red ocher, red lead, lead vermilion, cadmium red, cadmium mercury red, antimony vermilion, Permanent Red 4R, Para Red, Fire Red, p-chlor-o-nitroaniline red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, Bon Maroon Light, Bon Maroon Medium, Eosin Lake, Rhodamine Lake B, Rhodamine Lake Y, Alizarine Lake, Thioindigo Red B, Thioindigo Maroon, oil red, quinacridone red, pyrazolone red, polyazo red, chrome vermilion, benzidine orange, perynone orange, oil orange, cobalt blue, cerulean blue, Alkali Blue Lake, Peacock Blue Lake, Victoria Blue Lake, metal-free phthalocyanine blue, phthalocyanine blue, Fast Sky Blue, Indanthrene Blue (RS, BC), indigo, ultramarine, Prussian blue, anthraquinone blue, Fast Violet B, Methyl Violet Lake, cobalt violet, manganese violet, dioxane violet, anthraquinone violet, chrome green, zinc green, chromium oxide, viridian, emerald green, Pigment Green B, Naphthol Green B, Green Gold, Acid Green Lake, Malachite Green Lake, phthalocyanine green, anthraquinone green, titanium oxide, zinc oxide and lithopone. These may be used individually or in combination.

The color of the colorant is not particularly limited and may be suitably selected according to the purpose. For example, a black colorant, a color colorant, etc. may be used. These may be used individually or in combination.

Examples of the black colorant include carbon blacks (C.I. Pigment Black 7) such as furnace black, lamp black, acetylene black and channel black; metals such as copper, iron (C.I. Pigment Black 11) and titanium oxide; and organic pigments such as aniline black (C.I. Pigment Black 1).

Examples of color pigments for magenta include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:1, 49, 50, 51, 52, 53, 53:1, 54, 55, 57, 57:1, 58, 60, 63, 64, 68, 81, 83, 87, 88, 89, 90, 112, 114, 122, 123, 163, 177, 179, 202, 206, 207, 209 and 211; C.I. Pigment Violet 19; and C.I. Vat Red 1, 2, 10, 13, 15, 23, 29 and 35.

Examples of color pigments for cyan include C.I. Pigment Blue 2, 3, 15, 15:1, 15:2, 15:3, 15:4, 15:6, 16, 17 and 60; C.I. Vat Blue 6; C.I. Acid Blue 45, copper phthalocyanine pigments each having as substituent(s) one to five phthalimidemethyl groups on the phthalocyanine skeleton, Green 7 and Green 36.

Examples of color pigments for yellow include C.I. Pigment Yellow 0-16, 1, 2, 3, 4, 5, 6, 7, 10, 11, 12, 13, 14, 15, 16, 17, 23, 55, 65, 73, 74, 83, 97, 110, 151, 154 and 180; C.I. Vat Yellow 1, 3 and 20, and Orange 36.

The amount of the colorant contained in the toner is not particularly limited and may be suitably selected according to the purpose; however, it is preferably in the range of 1% by mass to 15% by mass, more preferably 3% by mass to 10% by mass. When the amount is less than 1% by mass, the coloring capability of the toner decreases. When the amount is greater than 15% by mass, pigment(s) is/are poorly dispersed in the toner, possibly leading to a decrease in coloring capability and degradation of electrical properties of the toner.

The colorant may be compounded with a resin to form a masterbatch. The resin is not particularly limited and may be suitably selected from resins known in the art, according to the purpose. Examples thereof include styrene polymers, polymers of substituted styrene, styrene copolymers, polymethyl methacrylate resins, polybutyl methacrylate resins, polyvinyl chloride resins, polyvinyl acetate resins, polyethylene resins, polypropylene resins, polyester resins, epoxy resins, epoxy polyol resins, polyurethane resins, polyamide resins, polyvinyl butyral resins, polyacrylic acid resins, rosins, modified rosins, terpene resins, aliphatic hydrocarbon resins, alicyclic hydrocarbon resins, aromatic petroleum resins, chlorinated paraffins and paraffins. These may be used individually or in combination.

Examples of the styrene polymers and the polymers of substituted styrene include polyester resins, polystyrene resins, poly-p-chlorostyrene resins and polyvinyltoluene resins. Examples of the styrene copolymers include styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-α-methyl chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer and styrene-maleic acid ester copolymer.

The masterbatch can be produced by mixing or kneading the colorant and the resin for use in a masterbatch, with the application of high shearing force. In doing so, an organic solvent is preferably added to enhance interaction between the colorant and the resin. Also, use of the so-called flushing method is suitable in that wet cake of the colorant can be used as it is, without requiring drying. The flushing method is a method in which an aqueous paste containing a colorant and water is mixed or kneaded with a resin and an organic solvent and then the colorant is transferred to the resin to remove water and components of the organic solvent. For this mixing or kneading, a high shearing dispersing device such as a triple roll mill is favorably used.

As described above, a charge controlling agent, an external additive and other component(s) may, if necessary, be used in the toner of the present invention.

### <Charge Controlling Agent>

The charge controlling agent is not particularly limited and may be suitably selected from charge controlling agents known in the art, according to the purpose. However, since use of a colored material may cause a change in color tone, use of a material which is colorless or whitish is preferable. Examples thereof include triphenylmethane-based dyes, molybdic acid chelate pigments, rhodamine-based dyes, alkoxy amines, quaternary ammonium salts (including fluorine-modified quaternary ammonium salts), alkylamides, phosphorus, phosphorus compounds, tungsten, tungsten compounds, fluorine-based activators, metal salts of salicylic acid and metal salts of salicylic acid derivatives. These may be used individually or in combination.

The charge controlling agent may be a commercially available product. Examples thereof include BONTRON P-51 (quaternary ammonium salt), E-82 (oxynaphthoic acid-based metal complex), E-84 (salicylic acid-based metal complex) and E-89 (phenolic condensate) (all manufactured by ORIENT CHEMICAL INDUSTRIES CO., LTD.); TP-302 and TP-415 (quaternary ammonium salt molybdenum complexes) (both manufactured by HODOGAYA CHEMICAL CO., LTD.); COPY CHARGE PSY VP2038 (quaternary ammonium salt), COPY BLUE PR (triphenylmethane derivative), COPY CHARGE NEG VP2036 and COPY CHARGE NX VP434 (quaternary ammonium salts) (all manufactured by Hoechst AG); LRA-901, and LR-147 (boron complex) (both manufactured by Japan Carlit Co., Ltd.); quinacridone, azo-based pigments, and polymeric compounds containing functional groups such as sulfonic acid group and carboxyl group, or quaternary ammonium salts.

The charge controlling agent may be dissolved and/or dispersed after melt-kneaded with the masterbatch, or may be directly added to the organic solvent together with the components of the toner when dissolved and/or dispersed, or may be fixed to the surfaces of toner particles after the formation of the toner particles.

The amount of the charge controlling agent contained in the toner depends upon the type of the binder resin, the presence or absence of additive(s), the dispersing process employed, etc. and therefore cannot be unequivocally defined. Nevertheless, the amount is preferably in the range of 0.1 parts by mass to 10 parts by mass, more preferably 0.2 parts by mass to 5 parts by mass, per 100 parts by mass of the binder resin. When the amount is less than 0.1 parts by mass per 100 parts by mass of the binder resin, favorable charge controlling properties may not be obtained. When the amount is greater than 10 parts by mass per 100 parts by mass of the binder resin, the chargeability of the toner is so great that main charge controlling agent effects are attenuated, and the electrostatic attraction force between the toner and a developing roller increases, which possibly leads to degradation of fluidity of a developer and/or a decrease in image density.

### <External Additive>

The external additive is not particularly limited and may be suitably selected from external additives known in the art, according to the purpose. Examples thereof include fine silica particles, hydrophobic silica, fatty acid metal salts (e.g. zinc stearate and aluminum stearate); metal oxides (e.g. titania, alumina, tin oxide and antimony oxide), and fluoropolymers. Among these, hydrophobized fine silica particles, hydrophobized fine titania particles, hydrophobized fine titanium oxide particles and hydrophobized fine alumina particles are favorable.

Examples of the fine silica particles include HDKH 2000, HDK H 2000/4, HDK H 2050EP, HVK21 and HDK H 1303 (all manufactured by Hoechst AG); and R972, R974, RX200, RY200, R202, R805 and R812 (all manufactured by NIPPON AEROSIL CO., LTD.). Examples of the fine titania particles include P-25 (manufactured by NIPPON AEROSIL CO., LTD.); STT-30 and STT-65C-S (both manufactured by Titan Kogyo, Ltd.); TAF-140 (manufactured by Fuji Titanium Industry Co., Ltd.); and MT-150W, MT-500B, MT-600B and MT-150A (all manufactured by TAYCA CORPORATION). Examples of the hydrophobized fine titanium oxide particles include T-805 (manufactured by NIPPON AEROSIL CO., LTD.); STT-30A and STT-65S-S (both manufactured by Titan Kogyo, Ltd.); TAF-500T and TAF-1500T (both manufactured by Fuji Titanium Industry Co., Ltd.); MT-100S and MT-100T (both manufactured by TAYCA CORPORATION); and IT-S (manufactured by ISHIHARA SANGYO KAISHA, LTD.).

The hydrophobized fine oxide particles, the hydrophobized fine silica particles, the hydrophobized fine titania particles and the hydrophobized fine alumina particles can be obtained by treating hydrophilic fine particles with silane coupling agents such as methyltrimethoxysilane, methyltriethoxysilane and octyltrimethoxysilane. Also, silicone oil-treated fine oxide particles and silicone oil-treated fine inorganic particles obtained by treating fine inorganic particles with a silicone oil, in a heated state if necessary, are suitable.

Examples of the silicone oil include dimethyl silicone oil, methylphenyl silicone oil, chlorphenyl silicone oil, methyl hydrogen silicone oil, alkyl-modified silicone oil, fluorine-modified silicone oil, polyether-modified silicone oil, alcohol-modified silicone oil, amino-modified silicone oil, epoxy-modified silicone oil, epoxy-polyether-modified silicone oil, phenol-modified silicone oil, carboxyl-modified silicone oil, mercapto-modified silicone oil, (meth)acrylic-modified silicone oil and α-methylstyrene-modified silicone oil.

Examples of the fine inorganic particles include fine particles of silica, alumina, titanium oxide, barium titanate, magnesium titanate, calcium titanate, strontium titanate, iron oxide, copper oxide, zinc oxide, tin oxide, silica sand, clay, mica, wollastonite, diatomaceous earth, chromium oxide, cerium oxide, colcothar, antimony trioxide, magnesium oxide, zirconium oxide, barium sulfate, barium carbonate, calcium carbonate, silicon carbide and silicon nitride. Amongst these, fine particles of silica and titanium dioxide are particularly preferable.

The external additive preferably occupies 0.1% by mass to 5% by mass, more preferably 0.3% by mass to 3% by mass, of the toner.

The average diameter of primary particles of the fine inorganic particles is preferably 100 nm or less, more preferably in the range of 3 nm to 70 nm. When it is so small as to be outside this range, the fine inorganic particles are easily embedded in toner particles, making it difficult for their function to be performed. When it is so large as to be outside this range, the surface of a latent electrostatic image bearing member is unevenly scratched, which is unfavorable. In the external additive, fine inorganic particles and/or hydrophobized fine inorganic particles may also be used; the average diameter of hydrophobized primary particles is preferably in the range of 1 nm to 100 nm, and it is more preferred that at least two types of fine inorganic particles having an average hydrophobized primary particle diameter of 5 nm to 70 nm be included in the external additive. It is even more preferred that at least two types of fine inorganic particles having an average hydrophobized primary particle diameter of 20 nm or less and at least one type of fine inorganic particles having an average hydrophobized primary particle diameter of 30 nm or greater be included in the external additive. Also, the specific surface area of the fine inorganic particles according to the BET theory is preferably in the range of 20 m²/g to 500 m²/g.

Examples of surface-treating agents for the external additive containing the fine oxide particles include silane coupling agents such as dialkyldihalogenated silane, trialkylhalogenated silane, alkyl trihalogenated silane and hexaalkyldisilazane, silylation agents, silane coupling agents containing alkyl fluoride groups, organic titanate-based coupling agents, aluminum-based coupling agents, silicone oil and silicone varnish.

Fine resin particles may also be added as the external additive. Examples thereof include polystyrenes obtained by soap-free emulsion polymerization, suspension polymerization or dispersion polymerization; copolymers of methacrylic acid esters and acrylic acid esters; polycondensation products of silicone, benzoguanamine and nylon; and polymer particles of thermosetting resins. With the additional use of such fine resin particles, it is possible to enhance the chargeability of the toner, reduce the amount of oppositely-charged toner and thereby reduce the occurrence of background smears.

The fine resin particles preferably occupy 0.01% by mass to 5% by mass, more preferably 0.1% by mass to 2% by mass, of the toner.

### <Other Component(s)>

The above-mentioned other component(s) is/are not particularly limited and may be suitably selected according to the purpose. Examples thereof include a fluidity improver, a cleanability improver, a magnetic material and metal soap.

Here, the fluidity improver means a fluidity improver capable of performing surface treatment to improve hydrophobicity and preventing degradation of flow properties and charging properties even at high humidity. Examples thereof include silane coupling agents, silylation agents, silane coupling agents containing alkyl fluoride groups, organic titanate-based coupling agents, aluminum-based coupling agents, silicone oil and modified silicone oil.

The cleanability improver is added to the toner to remove a developer remaining on a latent electrostatic image bearing member (photoconductor) and/or an intermediate transfer member after image transfer. Examples thereof include metal salts of fatty acids such as of stearic acid, e.g. zinc stearate and calcium stearate; and fine polymer particles produced by soap-free emulsion polymerization, e.g. fine particles of polymethyl methacrylate and polystyrene. As to the fine polymer particles, those which have a relatively narrow particle size distribution and which have a mass average particle diameter of 0.01 μm to 1 μm are favorable.

The magnetic material is not particularly limited and may be suitably selected from magnetic materials known in the art, according to the purpose. Examples thereof include iron powder, magnetite and ferrite. Among these, those which are white in color are preferable in terms of color tone.

### (Method for Producing Toner)

The method for producing the toner of the present invention is not particularly limited and may be selected from methods known in the art, such as kneading and pulverizing method, polymerization method, dissolution and suspension method, and atomization and granulation method, with preference being given to kneading and pulverizing method in view of productivity. It should be noted that the effects of the present invention can be sufficiently produced with the kneading and pulverizing method.

The kneading and pulverizing method is a method of melting and kneading toner materials which include a binder resin containing at least a polyester resin (A) and a polyester resin (B) as main components, a colorant, a release agent, and a graft polymer containing a polyolefin resin and a vinyl resin, then pulverizing and classifying the toner materials so as to produce base particles of the toner.

In the melting and kneading, the toner materials are mixed, and the mixture is melted and kneaded, placed in a melt kneader. Examples of the melt kneader include uniaxial/biaxial continuous kneaders, and batch kneaders based upon roll mills. Specific suitable examples thereof include a KTK-type biaxial extruder (manufactured by Kobe Steel, Ltd.), a TEM-type extruder (manufactured by TOSHIBA MACHINE CO., LTD.), a biaxial kneader (manufactured by KCK), a PCM-type biaxial extruder (manufactured by IKE GAI IRON WORKS, LTD.) and a co-kneader (manufactured by BUSS AG). The melting and kneading is preferably performed under appropriate conditions so as not to bring about cleavage of molecular chains of the binder resin. Specifically, the temperature at which the melting and kneading takes place is decided considering the softening point of the binder resin. When the temperature is far higher than the softening point, cleavage of the molecular chains occurs to a considerable extent. When the temperature is far lower than the softening point, dispersion of the toner materials may not sufficiently proceed.

In the pulverization, the kneaded materials obtained by the kneading are pulverized. Specifically, in this pulverization, it is preferred that the kneaded materials be coarsely pulverized first, then finely pulverized. To do so, a method of making the kneaded materials collide with a collision plate in jet airflow so as to pulverize them, a method of making particles of the kneaded materials collide with one another in jet airflow so as to pulverize them, or a method of pulverizing them in a narrow gap between a rotor being mechanically rotated and a stator is favorably employed.

In the classification, the pulverized materials obtained by the pulverization are classified so as to adjust the diameter of particles to a predetermined particle diameter. The classification can be performed by removing fine-particle components, for example with a cyclone separator, a decanter or a centrifuge.

Toner base particles having a predetermined diameter can be produced by classifying the pulverized materials in airflow with centrifugal force or the like after the pulverization and the classification have finished.

Subsequently, the external additive is added (externally added) to the toner base particles. By mixing and agitating the toner base particles and the external additive using a mixer, the external additive covers the surfaces of the toner base particles while being crushed. At this time, it is important in terms of durability that the external additive such as the fine inorganic particles and the fine resin particles be uniformly and firmly attached to the toner base particles.

The mass average particle diameter of the toner is not particularly limited and may be suitably selected according to the purpose. Here, the mass average particle diameter of the toner can be calculated as follows.
Measuring apparatus: COULTER MULTISIZER II (manufactured by Beckman Coulter, Inc.)
Aperture diameter: 100 μm
Analysis software: COULTER MULTISIZER ACCUCOMP ver. 1.19 (manufactured by Beckman Coulter, Inc.)
Electrolytic solution: ISOTON-II (manufactured by Beckman Coulter, Inc.)
Dispersion liquid: Emulgen 109P (manufactured by Kao Corporation; polyoxyethylene lauryl ether, HLB: 13.6) 5% electrolytic solution
Dispersion condition: 10 mg of a measurement sample is added to 5 mL of the dispersion liquid, which is followed by dispersion treatment for 1 minute with the use of an ultrasonic dispersing device, then 25 mL of the electrolytic solution is added, which is followed by dispersion treatment for 1 minute with the use of the ultrasonic dispersing device.
Measurement condition: The dispersion liquid and 100 mL of the electrolytic solution are poured into a beaker, then 30,000 particles are measured for diameter at a concentration that allows 30,000 particles to be measured for diameter in 20 seconds, and the mass average particle diameter of the particles is calculated from the particle size distribution.

### Developer

The toner of the present invention includes at least the toner materials, and the toner may be used as a developer which also includes suitably selected other component(s) such as a carrier. The developer may be a one-component developer or a two-component developer. However, in the case where the developer is used, for example, in an ultrahigh-speed printing system adaptable to present-day POD, it is preferred that the developer be a two-component developer in view of an increase in lifetime, etc.

The carrier is not particularly limited and may be suitably selected according to the purpose; however, preference is given to a carrier including a core material, and a resin layer that covers the core material.

The material for the core material is not particularly limited and may be suitably selected from materials known in the art. For example, manganese-strontium (Mn—Sr) materials (50 emu/g to 90 emu/g) and manganese-magnesium (Mn—Mg) materials (50 emu/g to 90 emu/g) are preferable. In terms of securing appropriate image density, highly magnetized materials such as iron powder (100 emu/g or greater) and magnetite (75 emu/g to 120 emu/g) are preferable. In terms of the fact that the contact force on a latent electrostatic image bearing member, where toner particles are disposed in an upright position, can be reduced and image quality can be advantageously improved, weakly magnetized materials such as copper-zinc (Cu—Zn) materials (30 emu/g to 80 emu/g) are preferable. These may be used individually or in combination.

The particle diameter of the core material as an average particle diameter (mass average particle diameter (D50)) is preferably in the range of 10 μm to 200 μm, more preferably 40 μm to 100 μm. When the average particle diameter (mass average particle diameter (D50)) is less than 10 μm, the amount of fine powder increases in the distribution of carrier particles, and this increase causes a decrease in magnetization per particle and thus possibly causes scattering of the carrier. When it is greater than 200 μm, the specific surface area of the carrier particles decreases, thereby possibly causing scattering of the toner, and possibly degrading reproduction of solid portions in the case of full-color images that contain plenty of solid portions.

The material for the resin layer is not particularly limited and may be suitably selected from resins known in the art, according to the purpose. Examples thereof include amino resins, polyvinyl resins, polystyrene resins, halogenated olefin resins, polyester resins, polycarbonate resins, polyethylene resins, polyvinyl fluoride resins, polyvinylidene fluoride resins, polytrifluoroethylene resins, polyhexafluoropropylene resins, copolymers of vinylidene fluoride and acrylic monomers, copolymers of vinylidene fluoride and vinyl fluoride, fluoroterpolymers (fluorinated triple (multiple) copolymers) such as a terpolymer composed of tetrafluoroethylene, vinylidene fluoride and a nonfluorinated monomer, and silicone resins. These may be used individually or in combination. Among these, silicone resins are particularly preferable.

The silicone resins are not particularly limited and may be suitably selected from generally known silicone resins according to the purpose. Examples thereof include straight silicone resins which contain organo-siloxane bonds only; and silicone resins modified with alkyd resins, polyester resins, epoxy resins, acrylic resins, urethane resins, etc.

The silicone resins may be commercially available products. Examples thereof as straight silicone resins include KR271, KR255 and KR152, manufactured by Shin-Etsu Chemical Co., Ltd.; and SR2400, SR2406 and SR2410, manufactured by Dow Corning Toray Silicone Co., Ltd.

The modified silicone resins may be commercially available products. Examples thereof include KR206 (alkyd-modified resin), KR5208 (acrylic-modified resin), ES1001N (epoxy-modified resin) and KR305 (urethane-modified resin), manufactured by Shin-Etsu Chemical Co., Ltd.; and SR2115 (epoxy-modified resin) and SR2110 (alkyd-modified resin), manufactured by Dow Corning Toray Silicone Co., Ltd.

These silicone resins may be used solely or in combination with components subject to cross-linking reaction, components for adjusting the charged amount, etc.

If necessary, the resin layer may contain conductive powder, etc. Examples of the conductive powder include metal powder, carbon blacks, titanium oxide, tin oxide and zinc oxide. The average particle diameter of any of these conductive powders is preferably 1 μm or less. When the average particle diameter is greater than 1 μm, it may be difficult to control electric resistance.

The resin layer can, for example, be formed by dissolving any of the above-mentioned silicone resins, etc. in a solvent so as to prepare a coating solution, then uniformly applying the coating solution over the surface of the core material by a coating method known in the art, which is followed by drying, and subsequently firing the dried coating solution. Examples of the coating method include immersion, spraying, and coating with the use of a brush.

The solvent is not particularly limited and may be suitably selected according to the purpose. Examples thereof include toluene, xylene, methyl ethyl ketone, methyl isobutyl ketone, cellosolve and butyl acetate.

The firing is not particularly limited and may be based upon external heating or internal heating. For example, the firing may be carried out in accordance with a method using a stationary electric furnace, a fluid-type electric furnace, a rotary electric furnace, a burner furnace, etc., or a method using a microwave.

The amount of the resin layer contained in the carrier is preferably in the range of 0.01% by mass to 5.0% by mass. When the amount is less than 0.01% by mass, it may be impossible to uniformly form the resin layer over the surface of the core material. When the amount is greater than 5.0% by mass, the resin layer is so thick that granulation among carrier particles occurs, thereby possibly making it impossible to obtain uniform carrier particles.

In the case where the developer is a two-component developer, the amount of the carrier contained in the two-component developer is not particularly limited and may be suitably selected according to the purpose. For example, it is preferably in the range of 90% by mass to 98% by mass, more preferably 93% by mass to 97% by mass.

As for the mixture ratio of the toner to the carrier in the two-component developer, in general, the amount of the toner is preferably in the range of 1 part by mass to 10.0 parts by mass per 100 parts by mass of the carrier.

### Image Forming Method

An image forming method of the present invention includes the steps of: charging a surface of a latent electrostatic image bearing member (photoconductor) by means of a charging unit; forming a latent electrostatic image on the surface of the photoconductor by means of an exposing unit; developing the latent electrostatic image as a toner image by means of a developing unit, using a toner (or a developer); transferring the developed toner image to a recording medium by means of a transfer unit; and fixing the transferred toner image by means of a fixing unit. The toner and the developer (two-component developer composed of the toner and a carrier) according to the present invention are useful in the image forming method.

The toner and the two-component developer, which is composed of the toner and a carrier, according to the present invention may be used, placed in a process cartridge. Specifically, the toner (or the developer) may be placed (supplied) into a process cartridge which is detachably mountable to an image forming apparatus main body and which includes the following members provided in a unified manner: a latent electrostatic image bearing member (photoconductor); and at least one unit selected from a charging unit configured to charge a surface of the photoconductor, an exposing unit configured to expose the charged surface of the photoconductor so as to form a latent electrostatic image, a developing unit configured to develop the formed latent electrostatic image with the use of the toner (or the developer), a transfer unit configured to transfer the developed toner image to a recording medium, and a cleaning unit configured to remove the toner remaining on the surface of the photoconductor after the transfer.

### Process Cartridge

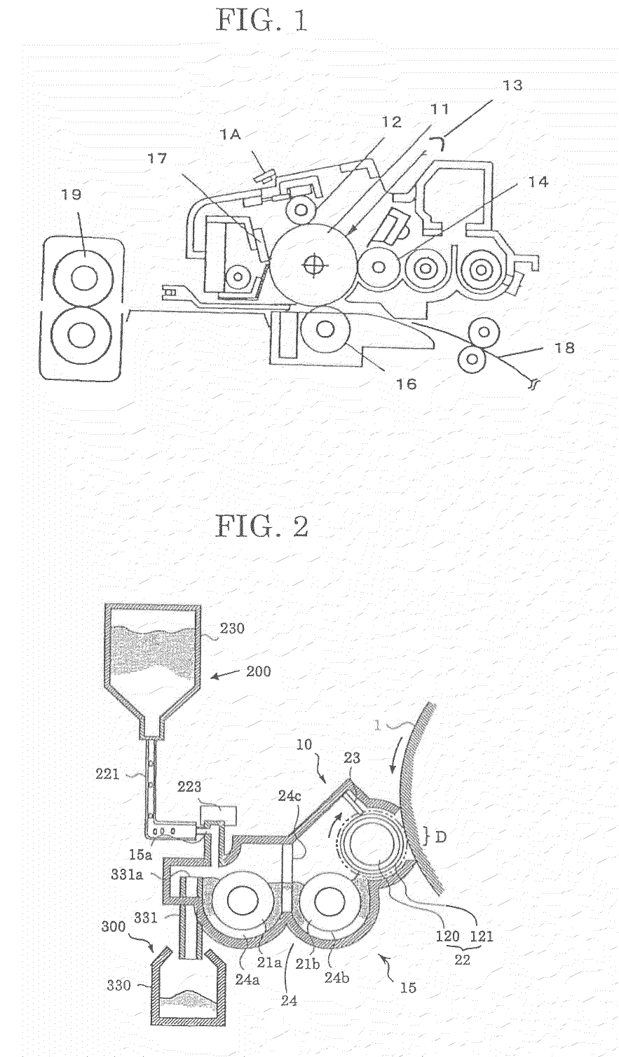

There are many examples of shapes, etc. regarding the process cartridge. Common examples of the process cartridge include the one shown in FIG. 1. Specifically, FIG. 1 is a schematic cross-sectional view showing a structural example of a process cartridge according to the present invention, including a latent electrostatic image bearing member (photoconductor) 11, and also including, around the photoconductor 11, a charging device 12 as a charging unit, an exposing device 13 as an exposing unit, a developing device 14 as a developing unit, a transfer device 16 as a developing unit, a cleaning device 17 as a cleaning unit, and a charge eliminating device 1A as a charge eliminating unit. In this case, the toner of the present invention is placed in the developing device 14. The numeral 18 denotes an image-receiving medium (e.g. paper). Although the photoconductor 11 is in the form of a drum, it may be in the form of a sheet or an endless belt. The numeral 19 denotes a fixing unit.

### Developer to be Supplied

A developer of the present invention to be supplied includes the above-mentioned toner of the present invention and a carrier. By using the developer in an image forming apparatus which forms images while allowing a surplus developer in a developing device to discharge, it is possible to obtain stable image quality over a very long period of time. Specifically, by employing a method of replacing a carrier which has degraded in the developing device with a carrier which has not degraded and is contained in a developer to be supplied, it is possible to keep the charged amount stable over a long period of time and thus obtain stable images. This method is effective, especially at the time of printing with a high image area. At the time of printing with a high image area, degradation of a carrier is accounted for mostly by degradation of charging of the carrier which is due to adhesion of spent toner to the carrier; here, it should be noted that when this method is employed, the supply of the carrier increases at the time of printing with a high image area, and thus replacement of the carrier which has degraded takes place more frequently. This makes it is possible to obtain stable images over a very long period of time.

As for the mixture ratio in the developer to be supplied, the amount of the toner is preferably in the range of 2 parts by mass to 50 parts by mass with respect to 1 part by mass of the carrier. When the amount of the toner is less than 2 parts by mass with respect to 1 part by mass of the carrier, the amount of the carrier supplied is too large, which causes a great increase in the concentration of the carrier in the developing device, and thus the charged amount of the developer easily increases. Also, the increase in the charged amount of the developer causes a decrease in developing capability and thus a decrease in image density. When the amount of the toner is greater than 50 parts by mass with respect to 1 part by mass of the carrier, the proportion of the carrier in the developer to be supplied is small, so that replacement of the carrier in the image forming apparatus does not frequently take place, and thus favorable effects on prevention of degradation of the carrier can hardly be expected.

### <Developing Device>

Here, the structure of a developing device, in which the developer of the present invention to be supplied can be used, and the surroundings of the developing device is explained. In FIG. 2, there is provided, above a developing device 10, a developer supplying device 200 for supplying a developer composed of an unused toner and an unused carrier into the developing device 10; and there is provided, below the developing device 10, a developer discharging device 300 for allowing the surplus developer in the developing device 10 to discharge.

The developing device 10 is composed mainly of: a housing 15 having a developer housing portion 24 which houses the two-component developer composed of the toner and the carrier; a developing roller 22 as a developer bearing and conveying member placed on the side of an opening portion of the housing 15 so as to rotate in a position which is close to a photoconductor 1 as an image bearing member; two conveying screws 21a and 21b as developer agitating and conveying members placed so as to rotate inside the developer housing portion 24; and a layer thickness control member 23 placed in contact with or close to the surface of the developing roller 22.

More specifically, the developing roller 22 is composed of a magnet roll 120 and a cylindrical sleeve 121 which is rotationally driven, the magnet roll 120 being fixed inside the sleeve 121. The developer housing portion 24 is divided in two by a partition wall 24 on the central side and composed of housing spaces 24a and 24b which communicate with each other via a communicating portion at both ends. By means of the conveying screws 21a and 21b rotating in the housing spaces 24a and 24b, the developer is conveyed in a circulating manner between the housing spaces 24a and 24b while being agitated. The layer thickness control member 23 has a dual structure composed of a nonmagnetic member and a magnetic member, and an end of the layer thickness control member 23 is placed so as to face a predetermined magnetic pole of the magnet roll 120.

The developer supplying device 200 is composed of a developer housing container 230 to house the two-component developer to be supplied, and a developer supplying member 221 for feeding the two-component developer in the developer housing container 230 to the developer housing portion 24. The developer supplying member 221 is provided so as to connect the developer housing container 230 and the developing device 10.

The developer discharging device 300 is composed of a collection container 330 with which to collect the two-component developer that has become a surplus developer in the developer housing portion 24, and a discharge pipe 331 as a developer discharging unit for sending the surplus developer that has overflowed the developer housing portion 24 to the collection container 330. The discharge pipe 331 is placed such that an upper opening 331a thereof is positioned at a predetermined height inside the developer housing portion 24, which allows the developer situated in a position higher than the upper opening 331a at the predetermined height to discharge through the discharge pipe 331.

A developer discharging device used in the present invention does not necessarily have the above-mentioned structure. For instance, the following is possible: a developer discharging outlet is provided in a predetermined place of the housing 15, a conveying member, e.g. a discharge screw, as a developer discharging unit is provided, instead of the discharge pipe 331, in the vicinity of the developer discharging outlet, and the developer discharged from the developer discharging outlet is thus conveyed to the collection container 330.

Also, this discharge screw may be provided at an end of or inside the discharge pipe 331 in the present embodiment.

Since the toner and the developer according to the present invention secure all of low-temperature fixability, offset resistance and heat-resistant storageability in a manner that is adaptable to an ultrahigh-speed image forming system, yield stable image density over a long period of time (during long-term use), have effectiveness notably in terms of smear-preventing capability of a developing roller, etc., and yield superior productivity, the toner and the developer are, for example, suitable in an ultrahigh-speed printing system adaptable to the field of electrophotographic print on demand (POD).

### EXAMPLES

The following explains Examples of the present invention. It should, however, be noted that the present invention is not confined to these Examples.

In Examples and Comparative Examples below, “softening point of resin”, “softening point of rosin compound”, “glass transition temperatures (Tg) of resin and rosin compound”, “acid values of resin and rosin compound”, “amount of low-molecular-weight components which are 500 or less in molecular weight”, “mass average particle diameter and particular size distribution (D₄/Dn) of toner”, and “number average molecular weight and weight average molecular weight of graft polymer” were measured as follows.

### <Measurement of Softening Point of Resin>

Using a flow tester (CFT-500D, manufactured by SHIMADZU CORPORATION), 1 g of a resin as a sample was heated at a temperature increase rate of 6° C./min and, while doing so, a load of 1.96 MPa was applied by a plunger so as to extrude the sample from a nozzle of 1 mm in diameter and 1 mm in length. The descent amount of the plunger of the flow tester was plotted against the temperature, and the temperature at which half the amount of the sample had flowed out was defined as the softening point.

### <Measurement of Softening Point of Rosin Compound>

### (1) Preparation of Sample

On a hotplate, 10 g of a rosin compound was melted at 170° C. for 2 hours. Thereafter, the rosin compound was naturally cooled at 25° C. and a relative humidity of 50% for 1 hour in an open state and then pulverized for 10 seconds using a coffee mill (National MK-61M, manufactured by Panasonic Corporation) so as to prepare a sample.

### (2) Measurement

Using the flow tester (CFT-500D, manufactured by SHIMADZU CORPORATION), 1 g of the sample was heated at a temperature increase rate of 6° C./min and, while doing so, a load of 1.96 MPa was applied by a plunger so as to extrude the sample from a nozzle of 1 mm in diameter and 1 mm in length. The descent amount of the plunger of the flow tester was plotted against the temperature, and the temperature at which half the amount of the sample had flowed out was defined as the softening point.

### <Measurement of Glass Transition Temperatures (Tg) of Resin and Rosin Compound>

Using a differential scanning calorimeter (DSC210, manufactured by Seiko Instruments & Electronics Ltd.), 0.01 g to 0.02 g of a sample was placed in an aluminum pan; subsequently, the sample was increased in temperature to 200° C., cooled from 200° C. to 0° C. at a temperature decrease rate of 10° C./min and then increased in temperature at a temperature increase rate of 10° C./min. The temperature at which an extended line of a baseline related to temperatures lower than or equal to the endothermic maximum peak temperature intersected a tangent having the maximum inclination between the starting point of the peak and the vertex of the peak was defined as the glass transition temperature.

### <Measurement of Acid Values of Resin and Rosin Compound>

The acid values of the resin and the rosin compound were measured in accordance with JIS K0070. It should, however, be noted that only the measurement solvent was changed from the mixed solvent of ethanol and ether prescribed in JIS K0070 to a mixed solvent of acetone and toluene [acetone:toluene=1:1 (volume ratio)].

<Measurement of Amount of Low-Molecular-Weight Components which are 500 or Less in Molecular Weight>

The molecular weight distribution was measured by gel permeation chromatography (GPC). First of all, 10 mL of tetrahydrofuran was added to 30 mg of each polyester-based binder resin, which was followed by mixing for 1 hour using a ball mill, then the mixture was filtered with a fluorine resin filter having a pore size of 2 μm (FP-200, manufactured by Sumitomo Electric Industries, Ltd.) so as to remove insoluble components, and a sample solution was thus prepared.

Next, tetrahydrofuran as an eluent was applied at a flow rate of 1 mL/min., an analytical column was stabilized in a constant-temperature bath whose temperature was set at 40° C., and 100 μL of the sample solution was poured into the analytical column for the measurement. GMHLX+G3000HXL (manufactured by TOSOH CORPORATION) was used as the analytical column, and a calibration curve of molecular weights was produced using several types of monodisperse polystyrenes (those having molecular weights of 2.63×10³, 2.06×10⁴ and 1.02×10⁵, manufactured by TOSOH CORPORATION; and those having molecular weights of 2.10×10³, 7.00×10³ and 5.04×10⁴) as standard samples.

Subsequently, the amount (%) of low-molecular-weight components which are 500 or less in molecular weight was calculated as the proportion of the area of a corresponding region in the chart area obtained using an RI (refractive index) detector.

### <Measurement of Mass Average Particle Diameter and Particular Size Distribution of Toner>

The mass average particle diameter and the particular size distribution of each toner were measured using a particle size measuring apparatus (MULTISIZER III, manufactured by Beckman Coulter, Inc.) with an aperture of 100 μm and analyzed using analysis software (BECKMAN COULTER MULTISIZER 3 Version 3.51).

Specifically, into a 100 mL glass beaker, 0.5 mL of a 10% (by mass) surfactant (alkylbenzene sulfonate, NEOGEN SC-A, manufactured by DAI-ICHI KOGYO SEIYAKU CO., LTD.) was poured, 0.5 g of each toner was poured, then these were stirred using a micro spatula. Subsequently, 80 mL of ion-exchange water was added. The obtained dispersion liquid was subjected to dispersion treatment for 10 minutes using an ultrasonic dispersing device (W-113MK-II, manufactured by Honda Electronics Co., Ltd.). A measurements was carried out on the dispersion liquid using the apparatus MULTISIZER III, also using ISOTON-III (manufactured by Beckman Coulter, Inc.) as a measurement solution. In the measurement, the dispersion liquid as a toner sample was applied dropwise such that the concentration shown by the apparatus became 8% by mass±2% by mass. In this measuring process, it is important that the concentration be 8% by mass±2% by mass in terms of reproducibility of the measurement of particle diameters. With this concentration range, there is no error in particle diameters.

As channels, the following 13 channels were used, and particles having diameters which are equal to or greater than 2.00 μm but less than 40.30 μm were targeted: a channel of 2.00 μm or greater but less than 2.52 μm; a channel of 2.52 μm or greater but less than 3.17 μm; a channel of 3.17 μm or greater but less than 4.00 μm; a channel of 4.00 μm or greater but less than 5.04 μm; a channel of 5.04 μm or greater but less than 6.35 μm; a channel of 6.35 μm or greater but less than 8.00 μm; a channel of 8.00 μm or greater but less than 10.08 μm; a channel of 10.08 μm or greater but less than 12.70 μm; a channel of 12.70 μm or greater but less than 16.00 μm; a channel of 16.00 μm or greater but less than 20.20 μm; a channel of 20.20 μm or greater but less than 25.40 μm; a channel of 25.40 μm or greater but less than 32.00 μm; and a channel of 32.00 μm or greater but less than 40.30 μm.

The mass and number of toner particles were measured, then the mass distribution and number distribution of the toner particles were calculated. The mass average particle diameter and particle size distribution of each toner were calculated from the obtained mass distribution and number distribution.

### <Measurement of Number Average Molecular Weight and Weight Average Molecular Weight of Graft Polymer>

The number average molecular weight (Mn) and the weight average molecular weight (Mw) were measured under the following conditions by GPC (gel permeation chromatography).

Apparatus: GPC-150C (manufactured by Waters Corporation)

Column: Shodex GPC KF-801 to KF-807 (manufactured by Showa Denko K.K.)

Temperature: 40° C.

Solvent: THF (tetrahydrofuran)

Flow rate: 1.0 mL/min

Sample: 0.1 mL of each sample having a concentration of 0.05% to 0.6% was poured.

Using the calibration curve of molecular weights, produced with the standard samples of the monodisperse polystyrenes, the number average molecular weight and weight average molecular weight of the toner were calculated from the molecular weight distribution of the toner resin measured under the above conditions.

A polyester resin (A), a polyester resin (B) and a graft polymer used for producing the toner were each synthesized as follows.

### Synthesis of Polyester Resin (A)

First of all, a rosin compound (fumaric acid-modified rosin) used for synthesizing polyester resins A1 to A4 was synthesized as follows.

### Synthesis Example (a)

### Synthesis of Fumaric Acid-Modified Rosin

Into a 10 L flask equipped with a fractionating tube, a reflux cooling tube and a receiver, 5,312 g (16 mol) of unrefined tall rosin and 928 g (8 mol) of fumaric acid were poured, the temperature was increased from 160° C. to 210° C. in 2 hours, the unrefined tall rosin and the fumaric acid were reacted together at 210° C. for 3 hours, then distillation was carried out at 210° C. and a reduced pressure of 4 kPa, and a rosin compound (rosin modified with fumaric acid: “fumaric acid-modified rosin”) was thus synthesized.

### Synthesis Examples (1) to (4)

### Synthesis of Polyester Resins A1 to A4

The alcohol component(s), the carboxylic acid components except trimellitic anhydride, and the esterification catalyst shown in Table 1 below were placed in a 5 L four-neck flask equipped with a nitrogen-introducing tube, a dehydration tube, an agitator and a thermocouple, then these ingredients were subjected to condensation polymerization reaction at 235° C. for 15 hours in a nitrogen atmosphere, and subsequently the ingredients were reacted together for 1 hour at 235° C. and 8.0 kPa. After lowering the temperature to 210° C., the trimellitic anhydride shown in Table 1 was poured, then the ingredients were reacted together for 1 hour at 210° C. and normal pressure (101.3 kPa) and subsequently reacted together at 210° C. and 10 kPa until a desired softening point was reached, and polyester resins A1 to A4 were thus each synthesized.

In Table 1 below, the values in parentheses concerning tin (II) 2-ethylhexanoate show molar concentrations [Note 1]. The amount of the rosin compound contained is shown as the ratio of the mass of the rosin compound to the total mass of the alcohol component(s) and the carboxylic acid components [Note 2]. The softening points, glass transition temperatures and acid values of the polyester resins A1 to A4 are also shown in Table 1 below.

TABLE 1

| | Synthesis Example | | | |
|---|---|---|---|---|
| | 1 | 2 | 3 | 4 |
| Polyester resin (A) No. | A1 | A2 | A3 | A4 |
| Alcohol components | | | | |
| 1,2-propanediol | 1,142 g | 1,142 g | 1,142 g | 914 g |
| 1,3-propanediol | — | — | — | 228 g |
| Carboxylic acid components | | | | |
| Terephthalic acid | 1,743 g | 2,409 g | 2,132 g | 1,743 g |
| Trimellitic anhydride | 288 g | 288 g | 288 g | 288 g |
| Fumaric acid-modified rosin | 1,743 g | 184 g | 110 g | 1,743 g |
| Esterification catalyst | | | | |
| Tin (II) 2-ethylhexanoate | 24.6 g | 18.4 g | 18.4 g | 24.6 g |
| [Note 1] | (0.5) | (0.5) | (0.5) | (0.5) |
| Amount of aliphatic diol | 100 | 100 | 100 | 100 |
| contained in dihydric alcohol | | | | |
| component(s) (mol %) | | | | |
| Amount of 1,2-propanediol | 100 | 100 | 100 | 80 |
| contained in aliphatic | | | | |
| diol (mol %) | | | | |
| Amount of rosin compound | 35 | 5 | 3 | 35 |
| contained (% by mass) | | | | |
| [Note 2] | | | | |
| Properties of polyester resin (A) | | | | |
| Acid value (mgKOH/g) | 32.7 | 31.1 | 31.5 | 30.9 |
| Softening point (° C.) | 105.8 | 103 | 102.8 | 105 |
| Glass transition temperature | 57.3 | 58.2 | 57.1 | 58.5 |
| (° C.) | | | | |

### Synthesis of Polyester Resin (B)

### Synthesis Examples (5) to (8)

### Synthesis of Polyester Resins B1 to B4

The alcohol component(s), the carboxylic acid components except trimellitic anhydride, and the esterification catalyst shown in Table 2 below were placed in a 5 L four-neck flask equipped with a nitrogen-introducing tube, a dehydration tube, an agitator and a thermocouple, then these ingredients were subjected to condensation polymerization reaction at 230° C. for 10 hours in a nitrogen atmosphere, and subsequently the ingredients were reacted together for 1 hour at 230° C. and 8 kPa. After lowering the temperature to 220° C., the trimellitic anhydride shown in Table 2 was poured, then the ingredients were reacted together for 1 hour at 220° C. and normal pressure (101.3 kPa) and subsequently reacted together at 220° C. and 20 kPa until a desired softening point was reached, and polyester resins B1 to B4 were thus each synthesized.

In Table 2, BPA-PO[*] and BPF-PO[**] denote the following.

BPA-PO[*] denotes bisphenol A propylene oxide adduct: polyoxypropylene(2,2)-2,2-bis(4-hydroxyphenyl)propane.

BPF-PO[**] denotes bisphenol F propylene oxide adduct: polyoxypropylene(2,2)-2,2-bis(4-hydroxyphenyl)methane.

The softening points, glass transition temperatures and acid values of the polyester resins B1 to B4 are also shown in Table 2.

TABLE 2

| Synthesis Example | | 5 | 6 | 7 | 8 |
|---|---|---|---|---|---|
| Polyester resin (B) No. | | B1 | B2 | B3 | B4 |
| Alcohol | BPA-PO[*] | 517 g | — | 258 g | 517 g |
| components | BPF-PO[**] | — | 380 g | — | — |
| | 1,2-propanediol | — | 23 g | 57 g | — |
| Carboxylic acid | Terephthalic acid | 125 g | 125 g | 150 g | 150 g |
| components | Itaconic acid | 78 g | 78 g | 39 g | 39 g |
| | Trimellitic anhydride | 144 g | 144 g | 173 g | 173 g |
| Esterification | Tin (II) 2-ethylhexanoate | 4 g | 4 g | 4 g | 4 g |
| catalyst | | | | | |
| Amount of bisphenol compound contained in | | 100 | 80 | 50 | 100 |
| alcohol component(s) (mol %) | | | | | |
| Properties of | Softening point (° C.) | 112 | 90.2 | 111.7 | 118.5 |
| polyester | Glass transition | 61.5 | 60.2 | 60.3 | 62.1 |
| resin (B) | temperature (° C.) | | | | |
| | Acid value (mgKOH/g) | 10.4 | 5.6 | 13.3 | 27.8 |

### Synthesis Example (9)

### Synthesis of Graft Polymer

In an autoclave reactor equipped with a thermometer and an agitator, 450 parts by mass of xylene and 100 parts by mass of low-molecular-weight polyethylene (SANWAX LEL-400, manufactured by Sanyo Chemical Industries, Ltd.; softening point: 128° C.) were placed such that the polyethylene was sufficiently dissolved in the xylene, then nitrogen substitution was carried out. Thereafter, a mixed solution of 755 parts by mass of styrene, 100 parts by mass of acrylonitrile, 45 parts by mass of butyl acrylate, 21 parts by mass of acrylic acid, 36 parts by mass of di-t-butyl peroxyhexahydroterephthalate and 130 parts by mass of xylene was applied dropwise at 170° C. for 3 hours to effect polymerization, then the mixture was held at this temperature for 0.5 hours. Subsequently, the solvent was removed, and a graft polymer (number average molecular weight: 3,400, weight average molecular weight: 18,000, glass transition temperature: 65.0° C., SP value of vinyl resin: 11.0 (cal/cm³)^{1/2}) was thus obtained.

### Examples 1 to 10 and Comparative Examples 1 to 3

### Production of Toners 1 to 12

The raw materials, i.e. the binder resin(s), the release agent, the colorant and the graft polymer, shown in Table 3, were premixed in accordance with each formulation, using a Henschel mixer (FM10B, manufactured by Mitsui Miike Chemical Engineering Machinery, Co., Ltd.), then the mixture was melted and kneaded at a temperature of 100° C. to 130° C., using a biaxial kneader (PCM-30, manufactured by IKEGAI Corporation). The kneaded product obtained was cooled to room temperature and then coarsely pulverized so as to be 200 μm to 300 μm in diameter using a hammermill. Subsequently, the coarsely pulverized product was finely pulverized with appropriate adjustment of pulverization air pressure, such that it had a mass average particle diameter of 8.2 μm±0.3 using the supersonic jet pulverizer LABO JET (manufactured by NIPPON PNEUMATIC MFG. CO., LTD.), then the finely pulverized product was classified with appropriate adjustment of the louver aperture, such that it had a mass average particle diameter of 9.0 μm±0.2 μm and the amount of fine powder of 4 μm or less in particle diameter was 10% by number or less, using an airflow classifier (MDS-I, manufactured by NIPPON PNEUMATIC MFG. CO., LTD.), and toner base particles were thus obtained. Thereafter, 1.3 parts by mass of an additive (HDK-2000, manufactured by Clariant Ltd.) was mixed with 100 parts by mass of the toner base particles with agitation, and toners 1 to 12 were thus produced. In Table 3, the term “part” means “part by mass”.

TABLE 3

| | | Binder resins | | | | | | | | Graft |
|---|---|---|---|---|---|---|---|---|---|---|
| Example | Toner | Polyester resin (A) | | Polyester resin (B) | | Release agent | | Colorant | | polymer |
| Ex. 1 | Toner 1 | Resin A1 | 50 parts | Resin B1 | 50 parts | Paraffin wax | 5 parts | C.I. | 6 parts | 2 parts |
| | | | | | | | | Pigment | | |
| | | | | | | | | blue 15:3 | | |
| Ex. 2 | Toner 2 | Resin A1 | 50 parts | Resin B2 | 50 parts | Paraffin wax | 5 parts | C.I. | 6 parts | 2 parts |
| | | | | | | | | Pigment | | |
| | | | | | | | | blue 15:3 | | |
| Ex. 3 | Toner 3 | Resin A1 | 50 parts | Resin B3 | 50 parts | Paraffin wax | 5 parts | C.I. | 6 parts | 2 parts |
| | | | | | | | | Pigment | | |
| | | | | | | | | blue 15:3 | | |
| Ex. 4 | Toner 4 | Resin A2 | 50 parts | Resin B1 | 50 parts | Paraffin wax | 5 parts | C.I. | 6 parts | 2 parts |
| | | | | | | | | Pigment | | |
| | | | | | | | | blue 15:3 | | |
| Ex. 5 | Toner 5 | Resin A4 | 50 parts | Resin B1 | 50 parts | Paraffin wax | 5 parts | C.I. | 6 parts | 2 parts |
| | | | | | | | | Pigment | | |
| | | | | | | | | blue 15:3 | | |
| Ex. 6 | Toner 6 | Resin A1 | 90 parts | Resin B1 | 10 parts | Paraffin wax | 5 parts | C.I. | 6 parts | 2 parts |
| | | | | | | | | Pigment | | |
| | | | | | | | | blue 15:3 | | |
| Ex. 7 | Toner 7 | Resin A1 | 40 parts | Resin B1 | 60 parts | Paraffin wax | 5 parts | C.I. | 6 parts | 2 parts |
| | | | | | | | | Pigment | | |
| | | | | | | | | blue 15:3 | | |
| Ex. 8 | Toner 8 | Resin A1 | 30 parts | Resin B1 | 70 parts | Paraffin wax | 5 parts | C.I. | 6 parts | 2 parts |
| | | | | | | | | Pigment | | |
| | | | | | | | | blue 15:3 | | |
| Ex. 9 | Toner 9 | Resin A1 | 50 parts | Resin B4 | 50 parts | Paraffin wax | 5 parts | C.I. | 6 parts | 2 parts |
| | | | | | | | | Pigment | | |
| | | | | | | | | blue 15:3 | | |
| Comp. | Toner 10 | Resin A1 | 100 parts | — | — | Paraffin wax | 5 parts | C.I. | 6 parts | 2 parts |
| Ex. 1 | | | | | | | | Pigment | | |
| | | | | | | | | blue 15:3 | | |
| Comp. | Toner 11 | Resin A3 | 50 parts | Resin B1 | 50 parts | Paraffin wax | 5 parts | C.I. | 6 parts | 2 parts |
| Ex. 2 | | | | | | | | Pigment | | |
| | | | | | | | | blue 15:3 | | |
| Comp. | Toner 12 | Resin A1 | 50 parts | Resin B1 | 50 parts | Paraffin wax | 5 parts | C.I. | 6 parts | 0 parts |
| Ex. 3 | | | | | | | | Pigment | | |
| | | | | | | | | blue 15:3 | | |

### [Production of Carrier]

A coat material having the following composition was dispersed for 10 minutes with a stirrer so as to prepare a coat solution, then this coat solution and 5,000 parts by mass of a core material (Cu—Zn ferrite particles, mass average particle diameter: 80 μm) were poured into a coating device incorporating a rotary base plate disc and stirring blades in a fluidized bed, used to perform coating while forming a swirling flow, and the coat solution was thus applied onto the core material. The obtained coated product was fired at 280° C. for 2 hours in an electric furnace so as to produce a carrier.

### <Composition of Coat Material>

Toluene: 450 parts by mass
Silicone resin (SR2400, manufactured by Dow Corning Toray Silicone Co., Ltd.; nonvolatile components: 50% by mass): 450 parts by mass
Aminosilane (SH6020, manufactured by Dow Corning Toray Silicone Co., Ltd.): 10 parts by mass
Carbon black: 10 parts by mass

### [Production of Two-Component Developer: (Two-Component Developers 1 to 12)]

Using the type of Turbula mixer (manufactured by Willy A. Bachofen AG (WAB)) that performs agitation by means of the rolling motion of a container, 5% by mass of each of the toners 1 to 12 produced as described above and 95% by mass of the carrier produced as described above were uniformly mixed at 48 rpm for 5 minutes and charged. By doing so, two-component developers 1 to 12 were produced.

### [Production of Developer to be Supplied: (Developer 1 to be Supplied)]

Using the type of Turbula mixer (manufactured by Willy A. Bachofen AG (WAB)) that performs agitation by means of the rolling motion of a container, 1 part by mass of the carrier produced as described above and 10 parts by mass of the toner 3 produced as described above were uniformly mixed at 48 rpm for 3 minutes.

### [Performance Evaluation]

Next, regarding the toners 1 to 12 of Examples and Comparative Examples, the smear-preventing capability of a developing roller, the image density stability, the heat-resistant storageability, the cold offset resistance and the hot offset resistance were evaluated as follows. The results are shown in Table 4.

The smear-preventing capability of a developing roller, the cold offset resistance and the hot offset resistance were evaluated by supplying, into an image forming apparatus, the developers 1 to 12 and the toners 1 to 12 according to Examples and Comparative Examples or the developer 1 to be supplied.

Here, what was used as the image forming apparatus was a modified machine made by installing the developing device shown in FIG. 2 in the ultrahigh-speed digital laser printer IPSIO SP9500PRO (manufactured by Ricoh Company, Ltd.; printing speed 156 sheets/min. (A4 size, with the lengthwise side being the lateral side)) that employs a two-component developing system, a direct transfer system, and a fixing system with a heating roller. The developers 1 to 12 were supplied to the developer housing portion 24, and the toners 1 to 12 and the developer 1 to be supplied were supplied to the developer housing container 230.

### <Smear-Preventing Capability of Developing Roller>

Each developer was supplied to the modified machine based upon the ultrahigh-speed digital laser printer IPSIO SP9500PRO (manufactured by Ricoh Company, Ltd.), then charts with an image area of 5% were printed onto 100,000 sheets of paper; thereafter, the developer and the toner on a developing roller were removed, then smears on the developing roller at a white paper feeding portion were evaluated by visual observation, and the smear-preventing capability of the developing roller was thus evaluated.

### [Evaluation Criteria]

A: The developing roller was not at all smeared.

B: There were smears to such an extent that they were hardly recognizable by visual observation.

C: There were smears to such an extent that they could be barely noticed (similarly to the case of conventional toner).

D: There were smears to such an extent that they were clearly problematic or that they made the use difficult.

### <Image Density Stability>

Each developer was supplied to the modified machine based upon the ultrahigh-speed digital laser printer IPSIO SP9500PRO (manufactured by Ricoh Company, Ltd.), then charts with an image area of 5% were printed onto 100,000 sheets of paper; thereafter, the image density of a solid image was measured, and the image density stability was thus evaluated.

### [Evaluation Criteria]

A: The image density decreased by less than 0.1 compared with an initial image density.

B: The image density decreased by 0.1 or more but less than 0.2 compared with an initial image density (similarly to the case of conventional toner).

C: The image density decreased by 0.2 or more compared with an initial image density.

### <Heat-Resistant Storageability>

The heat-resistant storageability was measured using a penetrometer (manufactured by NIKKA Engineering Co., Inc.). Specifically, each toner was adjusted to weigh 10 g and then poured into a 30 mL glass container (screw vial) at a temperature of 20° C. to 25° C. and a relative humidity of 40% to 60%, and the container was closed with a lid. The glass container with the toner in was tapped 200 times and then left to stand for 48 hours in a constant-temperature bath whose temperature was set at 50° C.; thereafter, the penetration was measured using the penetrometer, and the heat-resistant storageability was evaluated in accordance with the following criteria. The greater the value of the penetration is, the better heat-resistant storageability the toner has.

### [Evaluation Criteria]

A: The value of the penetration was 20 mm or greater.

B: The value of the penetration was in the range of 15 mm to 19 mm (similarly to the case of conventional toner).

C: The value of the penetration was 14 mm or less.

### <Cold Offset Resistance>

Each developer was supplied to the ultrahigh-speed digital laser printer IPSIO SP9500PRO (manufactured by Ricoh Company, Ltd.), then a 1 cm×1 cm solid image with the amount of the toner being 0.20 mg/cm²±0.1 mg/cm² was formed on thick transfer paper (copy/print paper <135>, manufactured by NBS Ricoh Co., Ltd.). After that, SCOTCH MENDING TAPE 810 (24 mm in width; manufactured by 3M Company) was attached onto the solid image, and subsequently a 1 kg metal roller (50 mm in diameter; manufactured by SUS Corporation) was rolled at a rate of 10 mm/s back and forth 10 times over this tape. Finally, the tape was peeled off at a rate of 10 mm/s in a fixed direction, then the residual image rate was calculated using Equation (ii) below, based upon the image densities before and after the peeling off of the tape, and the cold offset resistance was evaluated in accordance with the following evaluation criteria.

Residual image rate (%)=(Image density after peeling off of tape/Image density before peeling off of tape)×100 [Equation (ii)]

### [Evaluation Criteria]

A: The residual image rate was 97% or more.

B: The residual image rate was 92% or more but less than 97%.

C: The residual image rate was 80% or more but less than 92% (similarly to the case of conventional toner).

D: The residual image rate was less than 80%.

### <Hot Offset Resistance>

Each developer was supplied to the ultrahigh-speed digital laser printer IPSIO SP9500PRO (manufactured by Ricoh Company, Ltd.), then a 1 cm×1 cm solid image with the amount of the toner being 0.40 mg/cm²±0.1 mg/cm² was formed on thin transfer paper (copy/print paper <55>, manufactured by NBS Ricoh Co., Ltd.). Subsequently, the solid image was fixed on the paper, changing the temperature of a fixing roller. The occurrence or absence of hot offset was assessed by visual observation, and the hot offset resistance was evaluated in accordance with the following criteria, defining the upper limit temperature at which hot offset did not occur as the fixation upper limit temperature.

### [Evaluation Criteria]

A: The fixation upper limit temperature was 240° C. or higher.

B: The fixation upper limit temperature was 220° C. or higher but lower than 240° C.

C: The fixation upper limit temperature was 180° C. or higher but lower than 220° C. (similarly to the case of conventional toner).

D: The fixation upper limit temperature was lower than 180° C.

TABLE 4

| | | | | Smear- | | | | |
|---|---|---|---|---|---|---|---|---|
| | | | | preventing | | Heat- | Cold | Hot |
| | | | | capability of | Image | resistant | offset | offset |
| Exam- | Two-component | Toner | For | developing | density | storage- | resis- | resis- |
| ple | developer | used | supply | roller | stability | ability | tance | tance |
| Ex. 1 | Developer 1 | Toner 1 | Toner 1 | A | B | B | B | B |
| Ex. 2 | Developer 2 | Toner 2 | Toner 2 | B | B | B | A | B |
| Ex. 3 | Developer 3 | Toner 3 | Toner 3 | C | C | C | B | C |
| Ex. 4 | Developer 4 | Toner 4 | Toner 4 | B | B | B | C | B |
| Ex. 5 | Developer 5 | Toner 5 | Toner 5 | B | B | B | B | B |
| Ex. 6 | Developer 6 | Toner 6 | Toner 6 | C | C | C | A | C |
| Ex. 7 | Developer 7 | Toner 7 | Toner 7 | A | B | C | B | B |
| Ex. 8 | Developer 8 | Toner 8 | Toner 8 | A | B | B | C | A |
| Ex. 9 | Developer 9 | Toner 9 | Toner 9 | B | B | B | B | B |
| Ex. 10 | Developer 3 | Toner 3 | Developer | C | B | C | B | C |
| | | | to be supplied | | | | | |
| Comp. | Developer 10 | Toner 10 | Toner 10 | D | D | D | B | D |
| Ex. 1 | | | | | | | | |
| Comp. | Developer 11 | Toner 11 | Toner 11 | B | C | C | D | B |
| Ex. 2 | | | | | | | | |
| Comp. | Developer 12 | Toner 12 | Toner 12 | C | D | C | C | B |
| Ex. 3 | | | | | | | | |

The results in Table 4 show that, in comparison with Comparative Examples 1 to 3, Examples 1 to 10 superiorly secure all of low-temperature fixability, offset resistance (hot offset resistance) and heat-resistant storageability in a manner that is adaptable to an ultrahigh-speed image forming system, yield favorable pigment dispersibility and have effectiveness notably in terms of smear-preventing capability of a developing roller, etc.

Hence, since the toner and the developer according to the present invention secure all of low-temperature fixability, offset resistance (hot offset resistance) and heat-resistant storageability in a manner that is adaptable to an ultrahigh-speed image forming system, yield stable image density over a long period of time and have effectiveness notably in terms of smear-preventing capability of a developing roller, etc., the toner and the developer are, for example, suitable in an ultrahigh-speed printing system adaptable to the field of electrophotographic print on demand (POD).

What is claimed is:

1. A toner comprising:
a binder resin containing at least a polyester resin (A) and a polyester resin (B) as main components;
a colorant;
a release agent; and
a graft polymer containing a polyolefin resin and a vinyl resin,
wherein the polyester resin (A) is a condensation product resulting from condensation polymerization between an alcohol component containing a dihydric alcohol compound, and a carboxylic acid component containing a rosin compound, and the rosin compound occupies 5% by mass or more of the total amount of the alcohol component and the carboxylic acid component, and
wherein the polyester resin (B) is a condensation product resulting from condensation polymerization between an alcohol component containing a dihydric alcohol compound which includes at least an alkylene oxide adduct of a bisphenol compound represented by General Formula (1) below, and a carboxylic acid component: 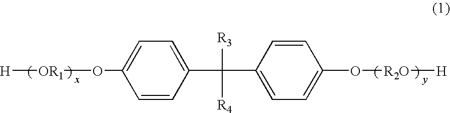
where R₁ and R₂ each denote an alkylene group having two to four carbon atoms, R₃ and R₄ each denote any one of a hydrogen atom, a straight-chain alkyl group having one to six carbon atoms, and a branched alkyl group having one to six carbon atoms, x and y each denote an integer of zero or greater, and the sum of x and y is in the range of 1 to 16.

2. The toner according to claim 1, wherein the rosin compound occupies 25% by mass to 40% by mass of the total amount of the alcohol component and the carboxylic acid component.

3. The toner according to claim 1, wherein the dihydric alcohol compound contained in the alcohol component used in the condensation polymerization for the polyester resin (A) contains an aliphatic diol, and the aliphatic diol occupies 65% by mole or more of the dihydric alcohol compound.

4. The toner according to claim 1, wherein the dihydric alcohol compound contained in the alcohol component used in the condensation polymerization for the polyester resin (A) contains an aliphatic diol, and the aliphatic diol occupies 80% by mole to 100% by mole of the dihydric alcohol compound.

5. The toner according to claim 3, wherein the aliphatic diol is 1,2-propanediol.

6. The toner according to claim 1, wherein the carboxylic acid component used in the condensation polymerization for the polyester resin (A) contains an aromatic dicarboxylic acid compound.

7. The toner according to claim 6, wherein the aromatic dicarboxylic acid compound is terephthalic acid.

8. The toner according to claim 1, wherein the dihydric alcohol compound contained in the alcohol component used in the condensation polymerization for the polyester resin (B) occupies 80% by mole or more of the alcohol component.

9. The toner according to claim 1, wherein the polyester resin (A) has an acid value of 25 mg KOH/g to 70 mg KOH/g, and the polyester resin (B) has an acid value of 1 mg KOH/g to 25 mg KOH/g.

10. The toner according to claim 1, wherein the mass ratio of the polyester resin (B) to the polyester resin (A), represented by (B)/(A), is in the range of 1/9 to 6/4.

11. The toner according to claim 1, wherein the mass ratio of the polyester resin (B) to the polyester resin (A), represented by (B)/(A), is 1/1.

12. The toner according to claim 1, wherein the polyolefin resin is polyethylene, and the vinyl resin is at least one selected from styrene, acrylonitrile, butyl acrylate and acrylic acid.

13. The toner according to claim 1, wherein the alkylene oxide adduct of the bisphenol compound represented by General Formula (1) is one of a bisphenol A propylene oxide adduct and a bisphenol F propylene oxide adduct.

14. The toner according to claim 1, wherein the release agent is a paraffin wax.

15. A developer to be supplied, comprising:
a toner; and
a carrier,
wherein the amount of the toner is in the range of 2 parts by mass to 50 parts by mass with respect to 1 part by mass of the carrier,
wherein the toner comprises a binder resin containing at least a polyester resin (A) and a polyester resin (B) as main components; a colorant; a release agent; and a graft polymer containing a polyolefin resin and a vinyl resin,
wherein the polyester resin (A) is a condensation product resulting from condensation polymerization between an alcohol component containing a dihydric alcohol compound, and a carboxylic acid component containing a rosin compound, and the rosin compound occupies 5% by mass or more of the total amount of the alcohol component and the carboxylic acid component, and
wherein the polyester resin (B) is a condensation product resulting from condensation polymerization between an alcohol component containing a dihydric alcohol compound which includes at least an alkylene oxide adduct of a bisphenol compound represented by General Formula (1) below, and a carboxylic acid component: 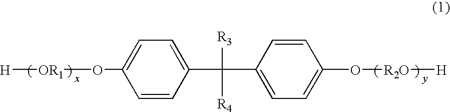
where R₁ and R₂ each denote an alkylene group having two to four carbon atoms, R₃ and R₄ each denote any one of a hydrogen atom, a straight-chain alkyl group having one to six carbon atoms, and a branched alkyl group having one to six carbon atoms, x and y each denote an integer of zero or greater, and the sum of x and y is in the range of 1 to 16.
